(19) United States
(12) Patent Application Publication
(10) Pub. No.: US 2007/0250362 A1
(43) Pub. Date: Oct. 25, 2007

(54) Method and system for valuing a venture

(75) Inventors: Nancy Vacante, Avon Lake, OH (US); Christian Alexander Maas, Redondo Beach, CA (US)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS AMERICA INC., Center Valley, PA (US)

(21) Appl. No.: 11/731,677

(22) Filed: Mar. 30, 2007

Related U.S. Application Data
(63) Continuation-in-part of application No. 10/835,624, filed on Apr. 30, 2004.

(51) Int. Cl. G06F 9/44

(52) U.S. Cl. 705/7

(57) ABSTRACT

A business planning and project facilitation method, program, and system for a new or existing venture is provided. Default values based on data retrieved from a knowledge database according to user-provided venture estimate information, are provided to the user. The user can enter additional information based on the user's estimate of a value for the venture to supplement and/or override at least one default value of the plurality of provided default values provided by the system. Based on the default value information and the user estimate information, a business plan customized for the venture is reported to the user. The database has information specific to a local business environment and detailed information about the industry of the target venture, including for example, ambulatory surgery centers and facilities, such as endoscopy. System, method and program storage device for providing valuation of a new or existing venture is also provided.

### CROSS-REFERENCE TO RELATED APPLICATIONS

This application is a continuation-in-part of U.S. patent application Ser. No. 10/835,624, filed Apr. 30, 2004.

### FIELD OF THE INVENTION

The present invention relates to the field of business planning and project facilitation systems, methods, and programs, such as planning for and project facilitation of a venture, including an existing or a new venture such as a facility for providing medical services, surgical procedures, and endoscopic services.

### BACKGROUND OF THE INVENTION

Starting a new business or venture, or launching a new operation of an existing facility requires anticipating the needs of the business, venture, or operation, and requires planning therefore. Also, starting an operation of a medical facility, office or venture, such as a surgical facility or an ambulatory care facility, or business modeling for an existing facility, such as costs, revenues and profitability of an existing hospital, hospital wing or unit thereof, involves planning for numerous tasks, financial needs and objectives, contingencies, and risks, and requires an understanding of the needs of the facility, including its operation, costs, staffing, accreditation, equipment, finances, profitability, and the like. Further, an entrepreneur may wish to obtain a feasibility study of a venture or a project involving such factors.

Business planning systems and software exist to aid entrepreneurs in planning for a new venture. For example, U.S. Patent Application Publication No. 2003/0074211 discloses an on-line real-time business planning website that allows the user to enter financial data, prospects, and goals as prompted by questions from the website, and to forecast financial reports and financial plans for the business.

However, the financial plan and forecast disclosed in the cited reference does not provide information customized to the industry and location of the venture. For example, the disclosure does not provide a system that includes detailed information about a particular) industry and type of venture, such as, for example, medical facilities, medical offices, hospitals, clinics, and practices providing medical services, including ambulatory care, surgical procedures and tests, and endoscopy services. Based on such detailed information, business planning and project facilitation can be custom-tailored to the specific needs, objectives and requirements of a new or existing venture.

Further, the cited reference does not disclose a system that provides a user with default values for the venture based on data from a database, which the user may override or supplement with venture-specific information and estimates for the venture, according to the estimates, needs and goals of the user specific to details of the venture and its operation. Also, the reference does not disclose a system that allows a user to enter confidence tags for venture-specific information used to flag values generated based on the tagged venture-specific information in generating the business plan and the project facilitation outline. Moreover, the cited reference does not disclose planning based on a business environment specific to the location of the proposed venture.

Similarly, U.S. Pat. Nos. 5,463,555 and 6,141,647 disclose an integrated business environment, process control environment and laboratory environment in which a business transaction system sends a work order to a manufacturing execution system, and uses rules from a database to generate set points for a manufacturing operation. When necessary for the manufacturing operation, the system may prompt a user to enter additional information, known as enrichment data. However, the above-discussed limitations and shortcomings with respect to U.S. Patent Application Publication No. 2003/00074211 apply also to U.S. Pat. Nos. 5,463,555 and 6,141,647.

There is a need therefore, for a business planning system that has access to detailed information about a location and a particular industry for the type of venture in which the user is interested, which provides default data customized for the type of venture and location of the venture specified, such that the user can supplement or override the default data provided by entering venture data or override/supplemental information, and confidence tags that may be used to flag values for the strategic business planning, facilitating and modeling scenarios. In this way a business plan or project facilitation outline can be provided by the system that is customized to the type of venture and location of the venture and may be based on venture-specific data and user estimate data for the venture.

In addition, there is a need for a system to present a business plan and/or a project facilitation outline for a venture, or a portion, project, unit or aspect of a venture, that is based on detailed information specific to medical facilities, offices, and practices, including ambulatory care, surgical procedures, or endoscopy services.

Further, there is a need for enabling valuation of such or other ventures, existing or new, for instance, to identify the financial value of entities such as medical facilities, offices, and practices, including ambulatory care, surgical procedures, or endoscopy services. Such valuation tool may be useful, for example, for a new potential partner that may be purchasing ownership into the ventures or facilities, for an exiting partner that may want to be divested of his ownership in an existing entity, a partner who needs to know the value of the facility for various purposes, etc.

### SUMMARY OF THE INVENTION

It is an object of this invention to provide a business planning method for a new venture, such that user-provided venture information is entered by a user, default values based on knowledge database-provided data are retrieved according to the user-provided venture information and user estimate data, and a business plan, model or project facilitation outline are provided to the user. According the present invention, the venture information may be provided to a system by a user, who has obtained the venture information from a client or customer or end user. At this point, the user may enter additional estimate information based on the user's estimate of a value or criterion for the venture to supplement and/or override at least one default value of the plurality of provided default values, a business plan customized for the venture, including average scores for the industry of the venture, taking into account values specific to a local business environment according to a location of venture, and based on the default value information and the user estimate information. The user may also be able to override or supplement venture information previously provided.

Further, the default values can include such things as requirements, including staffing and equipment, goals, forecasts, including revenue, volume, profitability/retum on investment or return on equity, costs, size, growth, and outputs for the endoscopy services venture.

Also, a user confidence tag for the user estimate information may be entered, and values and projections of the business plan may thus be flagged according to the user confidence tag for the estimate information. For example, the user confidence tag can represent a user estimate of the reliability of the tagged value.

The location of the venture may include information about a country, state, province, county, and/or town of the venture. Moreover, based on the information described above, project facilitation can be provided to facilitate user tracking and performance of tasks necessary for the venture.

According to an embodiment, detailed information about the industry of the venture would have to be available in the database to generate the business plan and to facilitate the project. For example, information specific to a local business environment and detailed information about the industry of the target venture, including for example, ambulatory surgery centers and facilities, such as facilities providing endoscopy services would be available for searching according to the information received from the user.

Also contemplated are a system and a program embodying the invention. Yet in another aspect, business valuation method, system and program storage device for an endoscopy services venture are provide. A business valuation method for an endoscopy services venture, in one aspect, may comprise receiving information associated with the endoscopy services venture; generating a preliminary valuation report based on the received information; providing the preliminary valuation report to a user; allowing the user to change the received information; and generating a valuation report customized for the endoscopy services venture based on the changed imformation.

Further features as well as the structure and operation of various embodiments are described in detail below with reference to the accompanying drawings. In the drawings, like reference numbers indicate identical or functionally similar elements.

### LIST OF FIGURES

The following figures and discussion describe embodiments of Applicant's invention as best understood presently by the inventors however, it will be appreciated that numerous modifications of the invention are possible and that the invention may be embodied in other forms and practiced in other ways without departing from the spirit of the invention. Further, features of embodiments described may be omitted, combined selectively or as a whole with other embodiments, or used to replace features of other embodiments, or parts thereof, without departing from the spirit of the invention. The figures and the detailed description are therefore to be considered as an illustrative explanation of aspects of the invention, but should not be construed to limit the scope of the invention. The scope of the invention is defined by the below-set forth claims.

FIG. 1 shows a process flow diagram according to an embodiment of the invention.

FIG. 2 shows a “Payor Mix” table generated by the system according to an embodiment of the invention and values entered by a user.

FIG. 3 shows as an example of default data a “Financial Goals” table provided by the system and values entered by a user according to an embodiment of the invention.

FIGS. 4a and 4b show an example of a project facilitation outline generated by a system according to an embodiment of the invention.

FIG. 5 shows reimbursement table modeling generated by the system according to an embodiment of the invention.

FIG. 6 shows a table with third-party information generated by the system according to an embodiment of the invention.

FIG. 7 shows features of a Generating Section 30 and Knowledge Database 35 according to an embodiment of the invention.

FIG. 8 shows a table with a breakout of total expenses for each family of procedure performed according to an embodiment of the invention.

FIG. 9 shows a graph and a table with a breakout of revenue provided by each unit according to an embodiment of the invention.

FIG. 10 shows a graph and a table with a breakout of revenue provided by each physician and a graph and a table with a breakout of revenue provided by each payer or insurer according to an embodiment of the invention.

FIG. 11 shows a graph and a table with a breakout of revenue provided by each CPT family according to an embodiment of the invention.

FIG. 12 shows a table with a breakout of costs for supplies and equipment for a venture according to an embodiment of the invention.

FIG. 13 shows a table with a listing of operating expenses for a venture according to an embodiment of the invention.

FIG. 14 is a table showing a financing cost calculator for a venture according to an embodiment of the invention.

FIG. 15 is a table showing cost for selected items and associated financing costs for a venture according to an embodiment of the invention.

FIG. 16 shows a “Recommended Facility Size” table listing the cost for selected items for a venture generated by the system based on user input according to an embodiment of the invention.

FIG. 17 is a flow diagram illustrating the valuation process of the present disclosure in one embodiment.

FIG. 18 illustrates an example input user interface for allowing a user to enter project objective data according to one embodiment of the present invention.

FIGS. 19A and 19B illustrate input user interface for allowing a user to enter modeling preference, for example, for existing practice.

FIGS. 20A and 20B illustrate a user interface via which a user may enter modeling preference for a new practice.

FIGS. 21A and 21B illustrate an example user interface via which a user may enter various risk factors for assessing risks considered in the valuation process.

FIGS. 22A-22H illustrate an example of a table that shows expenses for existing and new projected medical equipments or assets in the facility being valued.

FIGS. 23A and 23B illustrate an example of a table that shows expenses for existing and new projected non-medical equipments or assets in the facility being valued.

FIG. 24 illustrates upfront development cost. A user may inputs annual payments on remaining upfront development costs to identify debt load.

FIG. 25 illustrates the investment distribution in one embodiment.

FIG. 26A and FIG. 26B illustrate a user interface, for example, a table, in one embodiment that displays executive summary of the valuation.

FIG. 27 shows a user interface that presents procedure volume and reimbursement for existing and new practice.

FIG. 28 illustrates a table showing physician investment and return in one embodiment.

FIG. 29 illustrates a table showing outstanding debt summary in one embodiment.

FIG. 30 illustrates a table showing financing formulas that may be used in the valuation process in one embodiment.

### DETAILED DESCRIPTION

Features of the present invention are described by reference to embodiments involving a medical care facility. In particular, reference is made to an ambulatory medical care center, office, or facility, and an example involving an endoscopic services facility is described. However, it will be understood that Applicant's claimed invention may be have applicability in a variety of settings, including applications ranging from ambulatory care offices, facilities, surgical centers and facilities to clinics, hospitals and physicians' offices and other medical applications, as well as to applications for non-medical facilities, businesses and ventures.

Further, reference is made to starting or launching a new venture, however, it will be understood that the invention may also be useful for business planning and project facilitation for an on-going venture or for a new or continuing operation of an existing venture. Also, the invention may have applicability to modeling for an existing business or venture in order to obtain a better understanding of costs, revenue, return on investment, return on equity, and profits. For example, a hospital or a hospital wing or unit of a hospital may wish to identify existing costs. In a such a modeling application, the costs of existing equipment and infrastructure, including past, current and future financing costs, may have to be taken into account in modeling the costs and revenues of an on-going venture or unit thereof.

According to an embodiment of the invention, a user interested in planning for a venture, such as for example an ambulatory surgery center, may access a system designed according to the invention, such as a processor running software in accordance with the invention, such that the user is helped in planning business activities, tasks, financial requirements, financial returns, income streams, accreditation requirements and considerations, building size, expenses and equipment needs, staffing decisions, tax consequences, and other elements of the ambulatory surgery center or office, or endoscopic services facility. Accordingly, a database containing information specific to industries for ventures of different types, such as for the ambulatory surgery industry, is maintained and accessed by the system to help in the formulation of business plans and project facilitation outlines.

According to an embodiment of the invention, the system facilitates user access and use of specific modules or individual analysis functions and databases within the system. User may access only those analysis functions, databases, and system capabilities as required by the client or user in order to deliver the services requested.

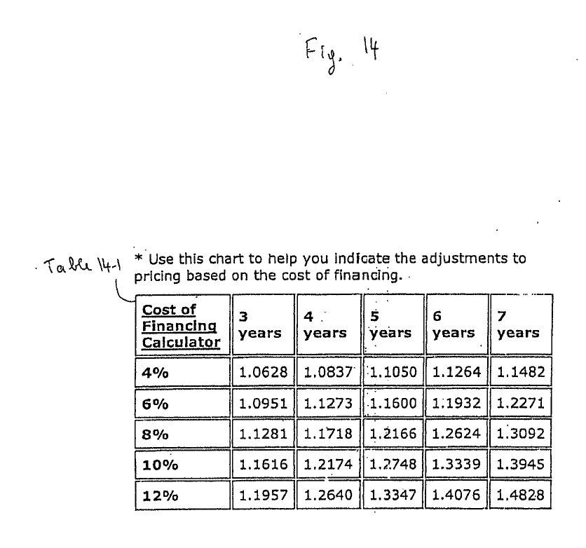

For an existing venture, an example, of the type of specific analysis that may be provided is the capture and input of the client's overall cost data and identifying the actual “cost per procedure” results. For example, for an existing hospital, operating costs, the costs of financing equipment and other infrastructure, and other expenses can be calculated and analyzed for each GI-related (Gastro-Intestinal Endoscopy) Current Procedure Terminology (CPT) code family, that is for each type of GI procedure, over, for example, a five-year projected time-frame. FIG. 8 shows a “Total Expenses by Family” table 8-1, showing the total operating and financing costs associated with each CPT family. (Bronchs are bronchoscopies, colons are colonoscopies, et cetera.) Thus, the current costs for each GI-related CPT code family can be identified and analyzed. With respect to the financing costs, as shown in FIG. 15, table 15-1, the financing costs associated with a venture, such as the Land and Building costs of row 15-1.2 and the Medical Equipment and Reprocessing Equipment costs of row 15-1.4 are broken out, together with the financing adjustment, shown in column 15-1.c, representing the cost of that item after the financing costs for the item are included. All expenses can therefore be individualized and appropriately allocated to each CPT family.

Similarly, for revenues from various types of procedures, as shown in FIG. 11, tables 11-1 and 11-2, specific departments of a hospital, as shown in FIG. 9, for individual physician, as shown in FIG. 10, tables 10-1 and 10-2, and for each type of insurance or payer, as shown in FIG. 10, tables 10-3 and 10-4 can be identified and analyzed. It will be understood that for other types of existing (or new) ventures, such costs and revenues for each type of service provided or good sold or for each unit or profit center of the venture, can be identified and analyzed, and a better understanding of profitability can thus be obtained using the business planning.

According to an embodiment of the invention, the system facilitates “modeling” of one or more business scenarios to provide the client with various strategic business options to consider or pursue. This exploration by a user through modeling of different options and strategies according to the modeling aspect of the invention is accomplished as the user enters venture information and user estimate information, making different assumptions about the venture and different forecasts about likely conditions that will prevail.

The business plan gives a user such data on costs, requirements, revenue, risks, profitability projections and other venture forecasts, while the project facilitation outline is provided as a guide for the user, to facilitate the user's development and operation of the venture. That is, the project facilitation outline provides the user with tasks to be completed and benchmarks to be borne in mind for various phases of the startup, completion, and operation of the venture, and allows the user to enter additional information as tasks are completed. Thus, a user can keep track of the progress of the development, construction, completion, start-up, and operation of the venture, and be kept informed of further tasks and requirements based on the tasks already completed.

According to an embodiment of the invention, a project facilitation section enables a user to be aided in tracking the activities necessary for the venture. For example, legal and government certification requirements, finance related tasks, facility acquisition, design and construction related activities, facility operations, tasks and information related to equipment purchase, operation or maintenance, staffing and employment needs, and the like, may be tracked. According to an embodiment, the user is also given recommended or estimated time duration information, so the user may anticipate the approximate time required for the completion of each task, or each phase of a task.

For example, FIG. 4B shows pages or portions of the project facilitation labeled with “R,” with links to “results” pages or portions. In an early stage of the startup of the venture, in the “Equipment-Tracking Follow-Up” portion of the project facilitation outline, the “track medical capital equipment”, and other aspects of the project are not yet complete. The user may be prompted at various stages of the project to follow up on various tasks required.

According to an embodiment, in the planning mode, the user may then test various options in real-time as part of the modeling of various options and strategies for the venture, in order to make strategic business decision possible. In this way, the chances are enhanced for developing an efficient, cost-effective venture, such as an ambulatory surgery center, that matches the personal and financial objectives of the user.

According to an embodiment, when the user knows exact values for customer volume, costs or other values, information may be entered with a high level of confidence using a confidence rating for the data entered. On the other hand, when a user is less certain of the information provided or when the certainty value is not known to the user at that time, the user will enter the information with a lower confidence rating. Also, when the user does not know or does not provide a confidence value, a default value confidence tag may be provided by a Generating Section 30, as shown for example in FIG. 7, based on information available from the database concerning the type of venture in the industry in question for the location proposed. According to an embodiment, default confidence tags are set to 100%, until changed by a user.

Features of the System

FIG. 7 shows features of the system according to an embodiment. User 20 accesses the Generating Section 30 via a link 21.

According to an embodiment, a user has licensed access to software embodying instructions to carry out instructions to perform as a Generating Section 30 of the invention. Also, such software may be sold to a user 20 or custom-configured for the user to be run on the user's processor, system, or LAN (Local Area Network). According to an embodiment, the Generating Section 30 may be accessed by the user via a network, such as the Internet, using for example a World Wide Web interface through which the user can interact with a server running the Generating Section 30 at a remote location, or with access to the Generating Section 30. When the user accesses the Generating Section 30 remotely via link 21 over the World Wide Web, the Generating Section 30, implemented, for example, as software run on the server or group of servers, may have access to a Knowledge Database 35 with detailed information about the target industry that concerns the venture proposed by the user.

The Generating Section 30 may be comprised of a User Interface 31, which handles data received from and provided to the User 20 and is controlled by the Controller 32. The Controller 32 processes the information received from the User Interface 31, generates data queries to the Knowledge Database 35 and coordinates the functioning of the Generating Section 30.

The Generating Section 30 may be implemented as software configured to be executed on a data processor comprised of instructions to the method according to the present invention. The Generating Section 30 may also be implemented as hardware, firmware or a combination of the foregoing, or as any other medium, apparatus, or system capable of providing the business planning and project facilitation functions as described herein.

The Knowledge Database 35 may be logically connected to the Generating Section 30 via a network link such as via a link on the World Wide Web, or may be integral to the Generating Section 30 or to a component thereof. For example, if the user is given a software package embodying the Generating Section 30, the Knowledge Database 35 may be provided therewith as part of the same package or on an additional package processed by the same data processor or by a data processor connected via a network. Further, if the Generating Section 30 is accessed via a network, the Knowledge Database 35 may be provided on the same server or as part of the same server network as the Generating Section 30, or may be accessed remotely by the Generating Section 30. It will also be understood that the Generating Section 30 maybe implemented as various modules and need not be executed on the same processor.

According to an embodiment, more than one user may collaborate to enter information to the Generating Section 30 and/or to review the business plan and the project facilitation outline returned by the Generating Section 30. Also, the Generating Section 30 could be accessed (information provided and received) from more than one processor, location or network. In this way, users, including users with different types of interest or expertise in the venture, may collaborate and/or share information.

According to an embodiment, the user who accesses the Generating Section 30 may be a person with some training or experience in using the system or in the target industry. For example, when a medical venture, such as a colonoscopy or endoscopy facility is being planned, modeled or facilitated, the user may be a nurse, registered nurse or other medical professional, or a person with business, legal, or financial background or training. Also, the user may be a person employed by a consulting company or by a company that licenses software embodying the system or sells access to the system, or a person working under direction of or under contract for such a company. Further, the user may be working for or under the direction of a company with access to the Generating Section 30 and communicating with a client, or customer, such as an end-user, about the client, customer or end user's proposed venture or modeling needs. Such communication by the user with the client, customer or end-user may be in person, in writing, over a telephone or data network, or by other means.

An Illustration of an Operation of the System

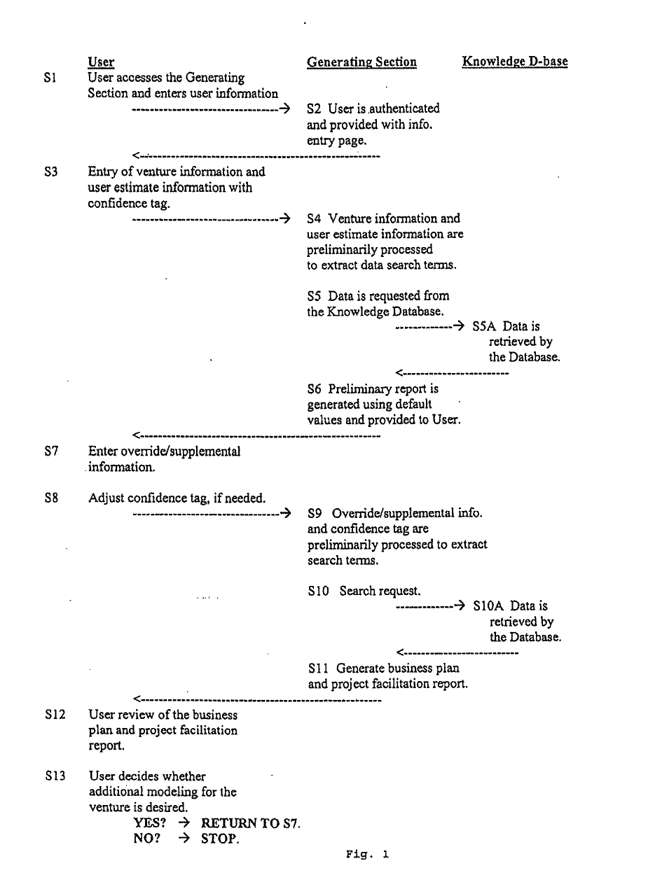

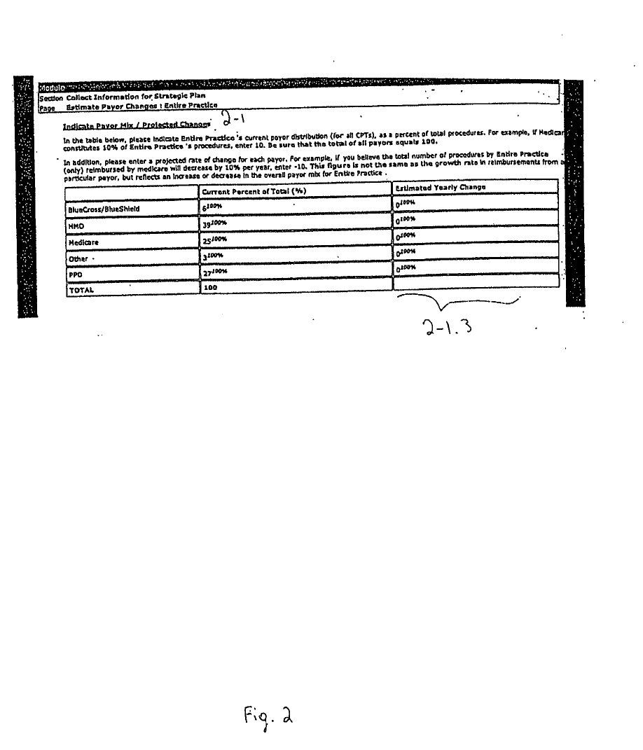

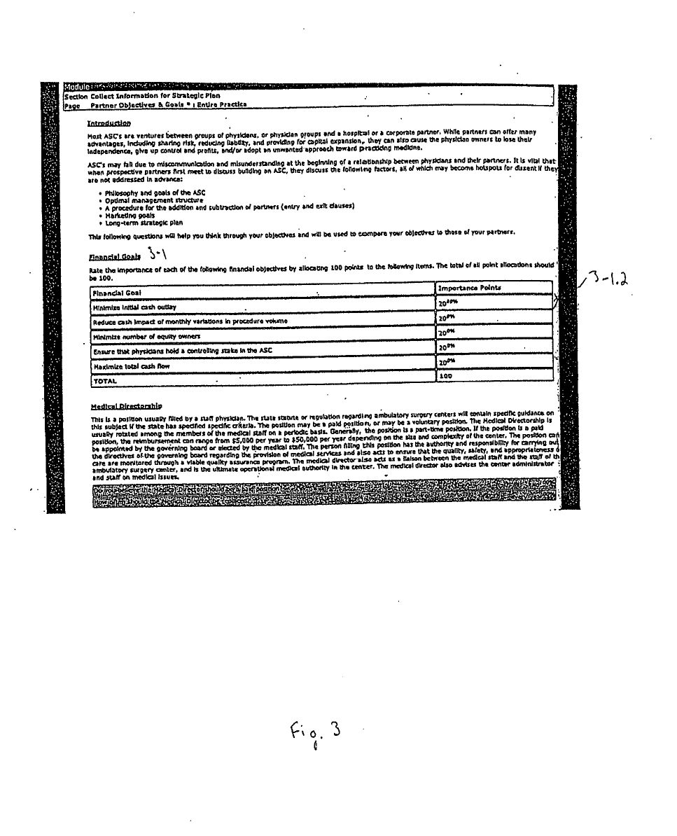

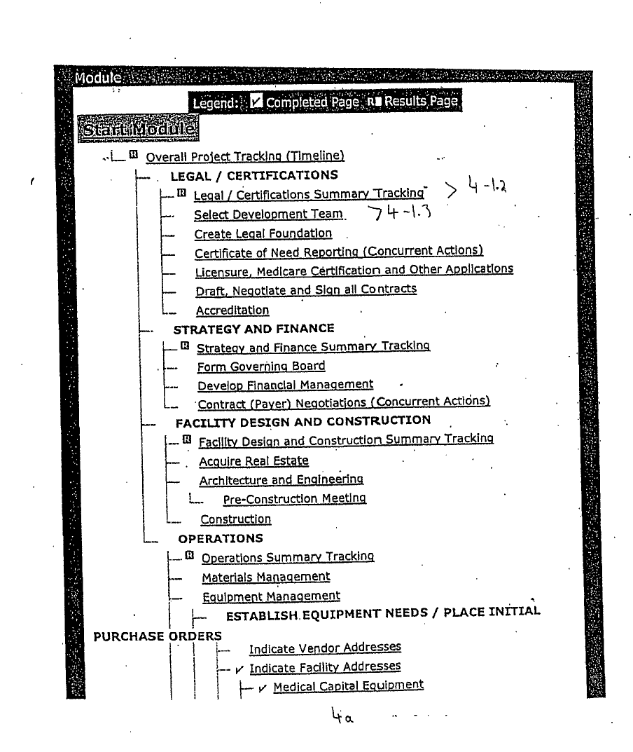

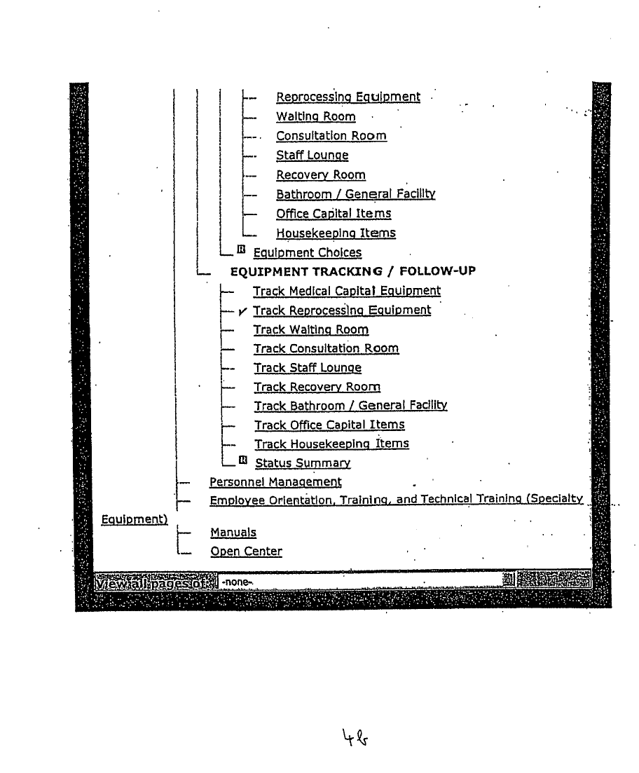

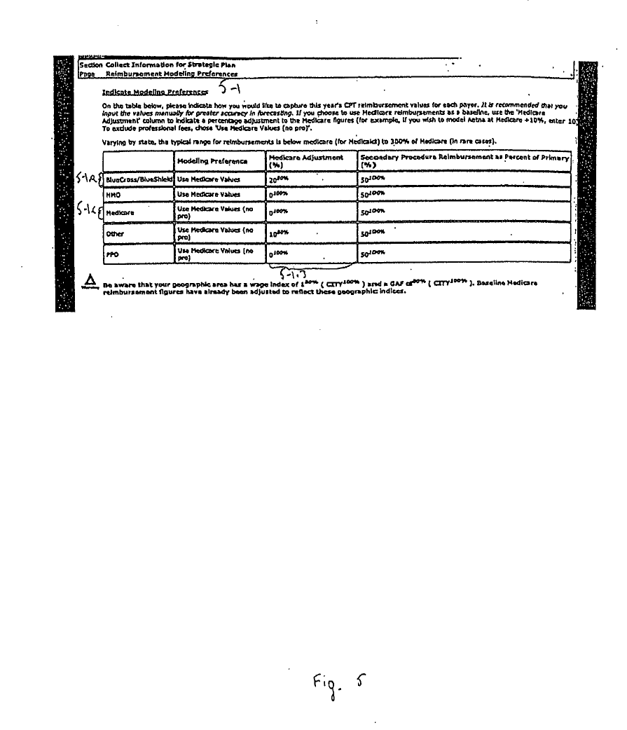

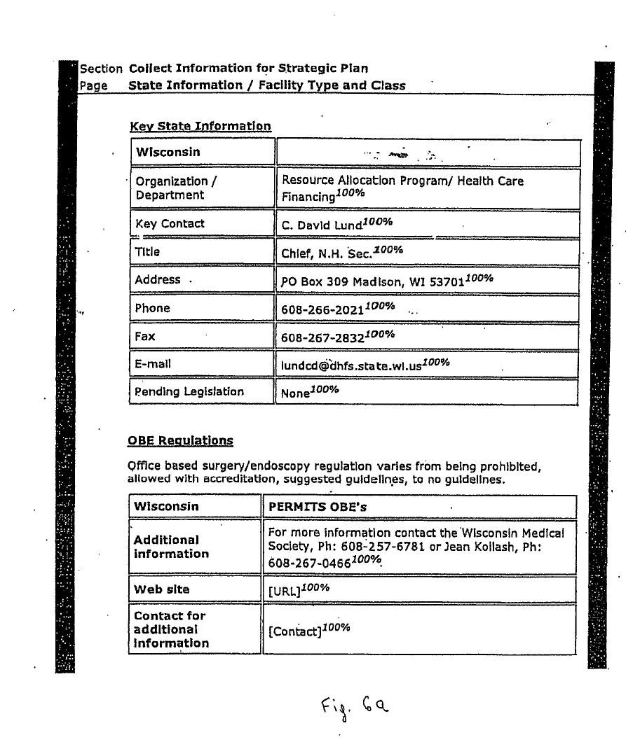

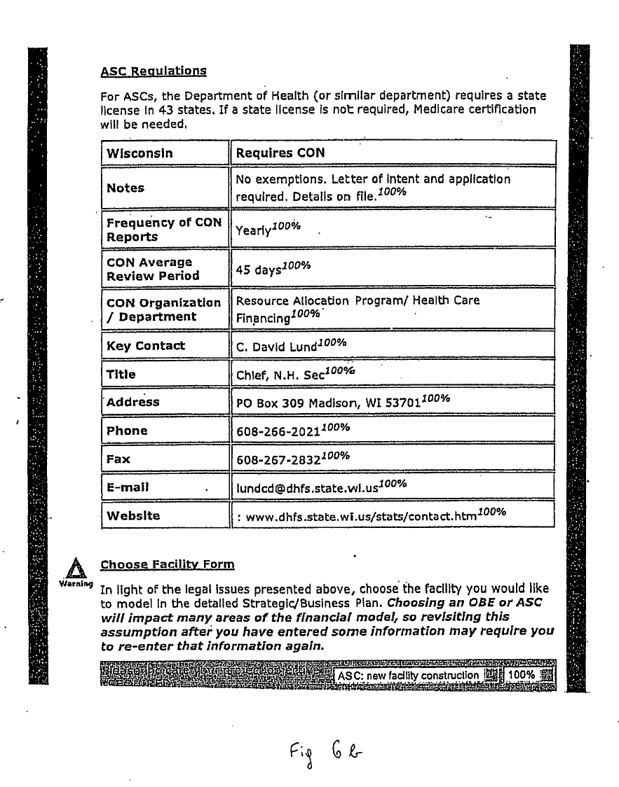

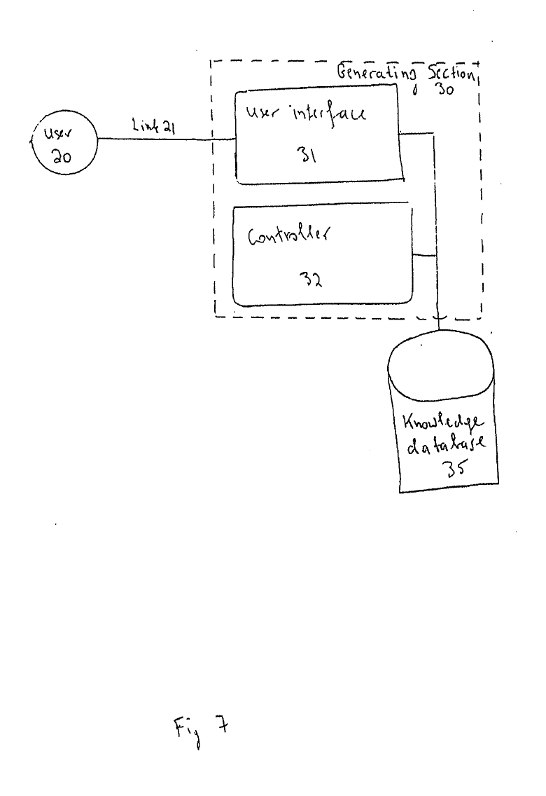

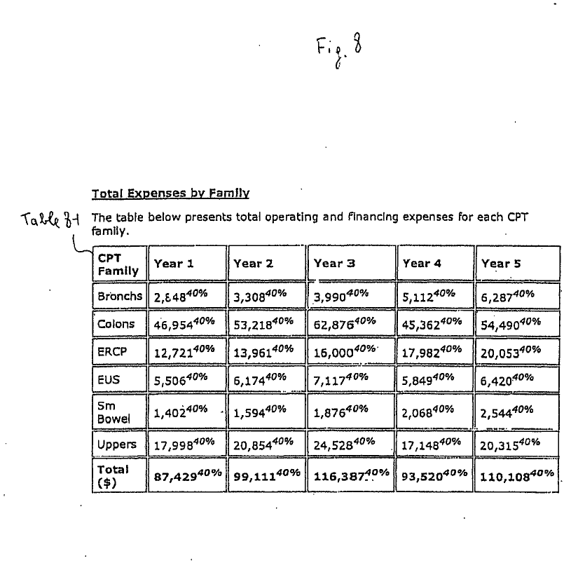

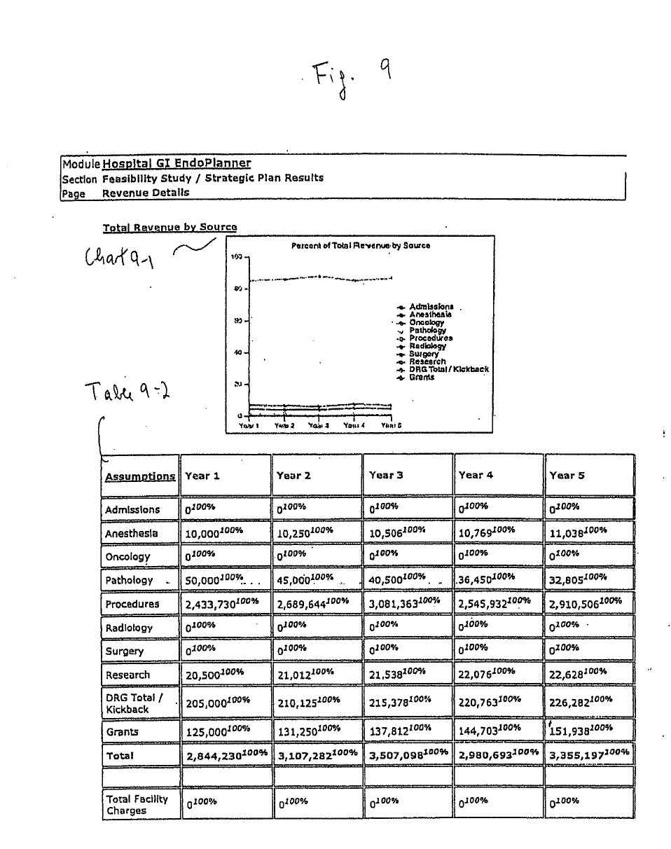

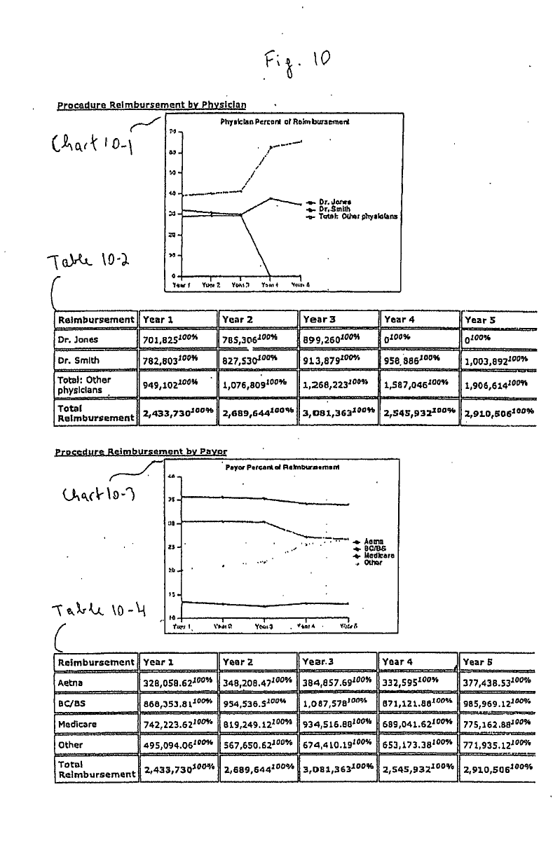

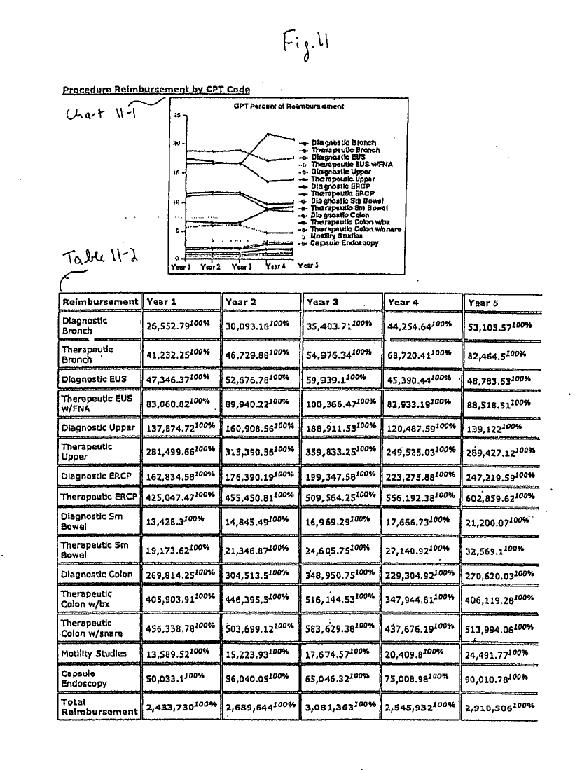

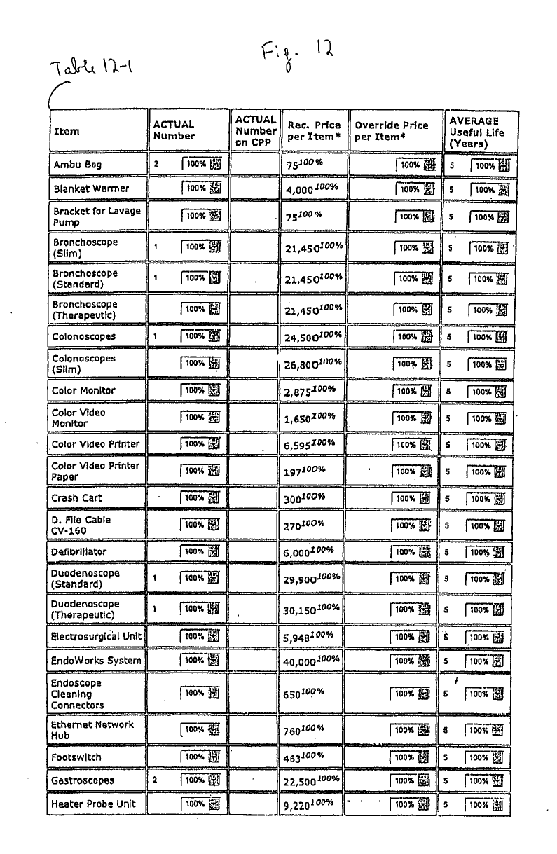

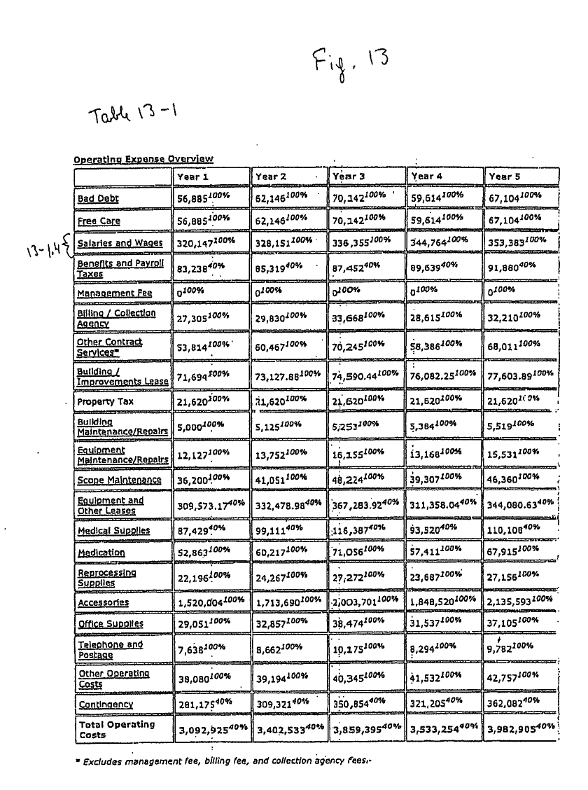

An illustrative example of an operation of the system according to an embodiment will now be illustrated using the process flow diagram shown in FIG. 1, and with reference to FIGS. 2-6.

At S1 of FIG. 1, a user interested in modeling a new venture, such as an endoscopic services facility, logs on to a network via a web or otherwise accesses the Generating Section 30. The user may be prompted to provide information to authenticate the user. Generating Section 30 authenticates the user at S2 using any one of a number of known authentications methods. For example, if the system is implemented via a world wide web interface for the system, the user may be required to submit a password with his or her name or credit card information. If the system is installed on the user's processor, system, or LAN (Local Area Network), the user may be requested to provide information sufficient to authenticate the user's license to use the system.

After the user is authenticated, at S3, the user enters venture information regarding the proposed venture. Such venture information may include basic information about the venture and its owners, principals or partners; contact information and the like; the industry or field or endeavor of the target venture, such as an ambulatory surgery center or ambulatory medicine, or an endoscopy services facility; the type of venture, such as ASC (Ambulatory Surgical Center) or physician's office, whether the facility is to be a multi-disciplinary or a single-specialty facility; for a hospital or clinic, whether the facility will be a public or private hospital, a teaching hospital, a community hospital, or a VA; the type of services that will be offered, such as endoscopic services. Some or all of this information may instead be entered at a later stage.

Location information may be also entered at this point. The location information may consist of the county and state of the proposed venture, and whether the location is to be in a metropolitan, suburban or rural area. Also, basic financial information about the venture may be entered such as the initial investment available, subsequent financing available, and the volume of patients or procedures forecast for the initial and subsequent years. The foregoing examples of venture information are not intended to be comprehensive. It will be understood that the information may be entered at this point or at a later point. Also, not all of this information may be necessary for any particular type of venture and some of the information may be entered at later stages of the operation of the system or not at all.

Further, the Generating Section 30 may be able to provide some or all of this information to the user based on the venture information entered by the user. For example, the Generating Section 30 may forecast the facility size, number of rooms and equipment, personnel and staffing and investment or the like necessary or desirable, based on the volume of procedures anticipated and entered by the user, and vice versa.

At S3, the venture information along with user estimate information (see below) is submitted to the Generating Section 30. The user may also enter a confidence tag, for example shown as a superscript to the first row right hand column “80%” of the “Financial Goals” table 3-1 of FIG. 3, as a tag for an entered value field. The use of the confidence tag by the system will be explained below. At S4, the Generating Section 30 preliminarily processes this information and sends one or more data requests to the Knowledge Database 35 based on the venture information.

Depending, for example, on the type of venture or the field of endeavor of the proposed venture, or on other venture information, the user may be guided to an appropriate Generating Section 30, or a module of the Generating Section 30, that is configured for that type of venture. Accordingly, a Generating Section 30 designed for an endoscopy services facility may be one module of the Generating Section 30 to which the user may be guided, while a different module of the Generating Section 30 designed for a non-medical application may be the one to which the user is guided based on the venture information submitted. In this vein, such Generating Sections or Generating Section modules need not be executed on the same data processor or computer. Similarly, the Knowledge Database 35 may be configured as database modules run on separate sites or with one or more processors.

After the venture information is preliminarily processed, such that search terms are extracted, at S5, the search terms are passed to the Knowledge Database 35, from which detailed information for the venture is retrieved (S5A).

At S6, based on the data received from the Knowledge Database 35, the Generating Section 30 generates a preliminary report using default values to complete required information. The generated report may include a business plan and/or a project facilitation outline, or a portion thereof, and is reported to the user for example, by displaying a web page to the user.

FIG. 2 shows an example in an ambulatory medical application of a page returned to the user with default values to indicate the payer mix and annual projected changes therefrom.

In addition, the user may be asked for supplemental information for the venture, as shown for example in FIG. 3. FIG. 3 shows a “Financial Goals” table, in which the user is requested to enter importance points for various financial goals for the venture.

As shown by the “Financial Goals” table, the financial, professional and other goals, requirements and conditions of each owner, principal, or professional involved with the venture may be reflected in the planning. For example, each physician's or owner's needs and goals can be reflected in the information entered for the “Financial Goals” table. In this way, the planning can assist in identifying potential risks or problems, or confirming whether the physicians or owners have needs, constraints and goals that are compatible. Shortfalls and financial or other constraints can thus be eliminated at an earlier stage of the process.

As shown in FIG. 3, the system may also provide textual information helpful for the user to provide information for the target venture useful to user and to respond to the request for supplemental information.

FIG. 3 describes that the user is provided with introductory information about ASC (Ambulatory Surgery Centers) and financial information in text form accompanying the “Financial Goals” table. It will be understood of course that this information, like the information of the business plan and project facilitation outline provided by the Generating Section 30, can be of a text form or may take the form of figures, charts, icons, attachments, web links, multi-media information, including audio and visual information designed to be displayed or played to, or to interact with the user.

The default data returned by the Generating Section 30 as part of the business plan and the project facilitation outline may be comprised of various types of data. This data may include:

financial, professional, available time, and other objectives and constraints of partners/owners/principals/directors/physicians, individually and collectively, for the venture;

the industry and the type of venture;

historical and projected data and statistics, such as payer mix (insurance types, Medicare and Medicaid, HMO patients, patient cash, et cetera);

customer, patient, procedure or gross sales/revenue volume estimates, inventory, purchases, forecasts, historical data, industry averages, benchmarks, and statistics;

reimbursement and payer information, which may be automatically calculated for wage index and geographical adjustment factors for Medicare, Medicaid, and all major payers or insurance;

reimbursement rates and amounts discounted automatically for secondary cases;

debt, bad debt, non-recoverable charges, and free care calculations;

facility size, revenue, and customer volume;

room-by-room facility outfitting and equipment needs, costs and schedules; medical and non-medical supplies and equipment needs and requirements for the venture,

including equipment and supply replacement costs and schedules;

pricing schedules, discounts and promotions for prospective customers/patients;

cost-of-living-increases, depreciation, amortization, and the like;

cash to reserve ratios and calculations;

tax estimates, tax timing, taxing preferences and other tax considerations for the venture as a whole and for owners and principals thereof;

corporate form and other considerations for the type of business entity optimal for the venture;

credit, mortgage, and financing parameters and options;

investment distribution options; detailed start-up expenses, including facility and equipment acquisition and construction, financing, maintenance and repair, incorporation, local, state and federal fees, penalties, and charges, and potential initial downtime for the facility;

market research, product research, product development, and prototype costs;

literature, convention, and marketing costs;

travel and entertainment costs; standard costs;

land size, zoning and site development needs and requirements, and time-frames for the foregoing;

break-even analysis, profitability, return on investment, return on equity, and EBITDA;

contingency cushions;

revenue and cost identification as they relate to procedure or service volume;

distribution patterns and costs;

contracted service needs, including consultants;

staffing needs and goals, including staff wages, payroll, and benefits;

information on state, local, federal and accreditation body licensing and accreditation for professionals and the facility;

required or desirable government or other applications, submissions, resolutions, meetings, bylaws, plans, and forms to be prepared or scheduled;

government and other inspections, approvals, certificates, fees, surveys and training, necessary;

continuing professional education and insurance;

other expenses detailed, such as marketing, IP licensing, and dues for equipment, office supplies, and the like;

utilities, insurance and operating costs for the facility; and

working capital requirements and forecasts.

According to an embodiment of the present invention, the default data are drawn from the Knowledge Database 35 with detailed information about the target industry to provide more accurate and comprehensive business planning and project facilitation. For example, in the endoscopic services application, sound planning requires that the plan take into consideration the distinctions in the law of many states between a facility that comes under the rubric of physician's office, Ambulatory Surgery Centers, hospitals, clinics, et cetera. An Ambulatory Surgery Center, for example, may be governed in some states by regulations particular to such centers, and such regulations should be taken into account in planning for the venture, obtaining licenses, accreditation, and permits, et cetera.

The Generating Section 30 can indicate the averages, “best practices,” industry benchmarks, and/or target values for the venture as part of the default data returned. The business standards may then be a starting point of the user's analysis in modeling for the venture, to develop a business plan consistent with the user unique circumstances, goals, forecasts, and objectives. That is, the business plan may be based on historical information for the industry and expertise acquired for the type of venture proposed, industry averages, and industry benchmarks and requirements, taking into account conditions specific to the local business environment of the venture.

Information about local business conditions may include land availability, zoning, development and construction requirements, and costs; legal requirements and considerations; staffing availability, costs for the various types of employees necessary; availability and cost of financing; cost of living and other expenses, and factors applicable to the region or area. In addition the business plan would also be based on supplemental and override information entered for the venture.

The user may override or supplement information provided as default values by the Generating Section 30. Some or all of the data and values enumerated above as default values may thus be entered by the user as user estimate information, supplemental information and/or override information. Thus, a user has a degree of control over the modeling of the business or venture assumptions.

For example, when specific sizes, costs, or other default quantities or values are calculated by the system, the user may be given opportunities to override or supplement those values and assumptions with venture-specific input values and forecasts to optimize the business plan that is generated. Thus, at S7, based on the information available to the user, including user business or venture operation experience and historical information available to the user (“track record”), estimate of relevant conditions, goals, perceived requirements, forecasts, operational or financial constraints or obligations, or the like, the user enters supplemental information, or overrides default data returned by the Generating Section 30, for example, by indicating the importance points in the right hand column of the “Financial Goals” table 3-1. By way of example, the user may point a cursor to the first row 3-1.2 of the “Importance Points” column, and indicate the importance of minimizing initial cash to pay for the venture, shown in FIG. 3 as 20 out of 100 in row 3-1.2. Values reflecting goals, constraints and priorities of individual owners or professionals of the venture, or its partners or shareholders (depending on the venture's business form), as well as of the venture as a whole, may be entered and taken into account in planning and modeling.

The supplement information may be information provided by the user responsive to a prompt by the Generating Section 30 that allows a user to enter information additional to the originally provided venture information about conditions or forecasts for the venture. The override information may be based on a user's knowledge of factors, conditions, or forecasts for the venture, when they are different from the Generating Section 30-provided default values. As discussed, the override information and supplement information may also represent a user's rating of the value of an outcome for the venture, see for example row 3-1.2 of FIG. 3.

In addition, at S8, as at S3, the user may enter a confidence tag, for example shown as a superscript to the first row right hand column “80%” of the “Financial Goals” table 3-1 of FIG. 3.

The confidence tag represents a user's confidence about a forecast or goal, or the degree of accuracy of historical data for the venture. For example, the Payor Mix/ Projected Change table 2-1 of FIG. 2 shows the confidence tag of the estimated yearly change in the right hand column, “Estimated Yearly Change” 2-1.3, for each of the yearly changes as 100%. The confidence tag may be a user's assessment of a likelihood of the prevalence of a present or future condition with regards to the venture.

After the user at S8 enters the confidence tag, the supplemental information and override information and the confidence tag are submitted to the Generating Section 30, which processes this information at S9. The Generating Section 30 at S10 may send for additional data from the Database, S10, as necessitated by the new information entered by the user.

The confidence tag may be used by the Generating Section 30 to flag information so tagged, information generated for the plan or model or facilitation based on the information tagged, and/or to flag other impacted information accordingly. For example, FIG. 5 includes a table entitled “Indicate Modeling Preferences” 5-1, showing reimbursement values for different insurers/payers for endoscopic services rendered. In the third column, “Medicare Adjustment” 5-1.3, the first row,(“BlueCross/Blue Shield” 5-1.a, shows that the Blue Cross/Blue Shield reimbursement rate at 20% higher than the Medicare figure shown in row 5-1.c of table “Indicate Modeling Preferences” 5-1. Together with further information, for example, with information about the percentage of endoscopy procedures reimbursed by the respective insurers/payers (not shown in FIG. 5), the “Medicare Adjustment” information (shown in the “Medicare Adjustment” column 5-1.3) may be useful in planning for income streams. However, the entry for the Blue Cross/Blue Shield reimbursement rate is tagged with a confidence tag of “80%” (superscript for the “20” in the first row of the “Medicare Adjustment” column 5-1.3), which shows that the user's estimate of the entry has a confidence value of 80%. Thus, the 80% confidence rating would according to this embodiment have to be used to flag any planning based on the 20% above Medicare reimbursement rate and values generated based on the 20% rate, including potentially any values derived from this value, with a reliability rating according to the confidence rating, for example with a reliability of 80%.

The Generating Section 30 processes the override and/or supplemental information received.

At this point, the Generating Section 30 optionally extracts search terms to produce a search request for additional searching of the Knowledge Database 35 (S9). On the other hand, if the Generating Section 30 determines that no further information from the Knowledge Database 35 is necessary, then these steps may be omitted. At S10, the search request is passed to the Knowledge Database 35, which retrieves the additional information and provides it to the Generating Section 30 at S10A.

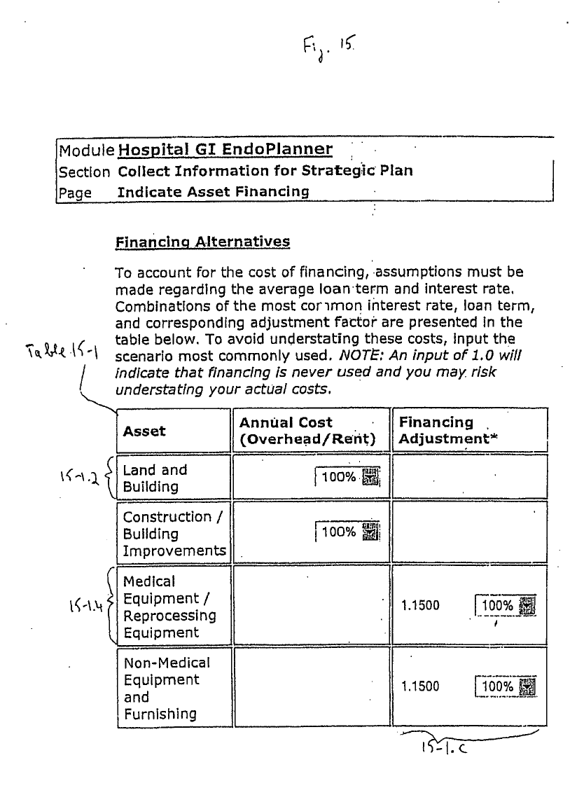

At S11, the Generating Section 30 generates a business plan and a project facilitation page based on the information retrieved and reported to the user. For example, based on a user estimate of the number of procedures to be performed for a given period (or based, for example, on gross sales in other applications of the invention) by the venture, the Generating Section 30 obtains information about the size of the facility, types and number of medical equipment required to provide the services. According to an embodiment, the number of procedures forecast may be keyed to a LUT (look up table) in the Knowledge Database 35, and the size of the facility and type and number of medical equipment required is returned. For example, the LUT may have a range corresponding to a number of procedures of a certain type as an entry, and a forecast of a number of procedures falling into that range will return a size of the facility, types and number of medical equipment required to provide the services. FIG. 16 shows an illustrative “Recommended Facility Size” table showing a size, number of rooms and the like recommended for an ASC (Ambulatory Surgery Center) forecast for several years, based on a number of procedures estimate entered by the user. For this example, default confidence tags are illustratively set at 100%.

In turn, based on the size of the facility and equipment required, estimates of the staffing, supply and other needs of the venture may be obtained from the Knowledge Database 35 and provided to the user. It will be understood that portions or aspects of the business plan and the project facilitation outline may be provided to the user in sections as they become available according to the information from the user and database. For example, a user may wish to model or facilitate only a unit or profit center or aspect of a venture and enter venture data only for that unit or profit center or aspect of a venture. The system would model or plan or facilitate for only that part of the venture, based on the information available.

For example, FIGS. 4A and 4B show a summary of a project facilitation outline provided to the user in which certain sections are summary pages listing results pages (illustratively tagged as “R”), for example, the “Legal/Certifications Summary Tracking” section 4-1.2, while other pages representing portions of the projection facilitation report are subset tasks, for example, the “Select Development Team” 4-1.3. Thus, information for the sections or modules of the business plan and of the project facilitation outline may be individually completed by the user and the respective completed sections generated and provided by the Generating Section 30 to the user. It will be understood that the project facilitation outline may be of a form that facilitates interaction with the user, such that the user may enter values and check off tasks as they are completed. For example, FIGS. 4A and 4B show a page displayed to a user on a user's display, such as a computer monitor or display, that provides the necessary information to the user.

Further, a field returned as part of a results page may be linked to a data input page, such that for example by selecting or “clicking” on the field, the user may be returned to a corresponding data entry page and given a further opportunity to view, adjust, update, correct or supplement corresponding data or data related to the corresponding data. For example, an “Operating Expense Overview” table 13-1 of FIG. 13 contains a “Salaries and Wages” row 13-1.4 with estimates for future years of the venture. The underlining of the words “Salaries and Wages” of the row heading of the “Salaries and Wages” row 13-1.4 may indicate that a user can click on that field and be linked to a data input page where more detailed information about costs associated with staff salaries, wages and related expenses were listed. The user can view this more detailed information to get a better idea of the factors and assumptions that went into the total “Salaries and Wages” expenses, and/or update, adjust, correct or supplement such detailed breakout items. For example, by selecting a corresponding item listed in table 13-1 of FIG. 13, the user is given access to a set of data, such as shown in FIG. 12, table 12-1, which shows the values that served as the basis for the equipment expenses.

At S12, a user reviews the information generated. The business plan and project facilitation outline may include detailed information about forecasts and needs of the target venture, including information such as legal requirements, insurance, facilities development and operations, building maintenance and repair, government (state, local and federal) licensing and accreditation, financial, accounting, tax, staffing, employment rules, equipment and supply procurement and need, industry environment and benchmark information about location. The types of information returned may be of the same type of information as the default data returned, discussed above.

There may also be provided contact information and links, such as world wide web links, to third parties relevant to the venture, such as state, federal, local government and professional accreditation or licensing bodies, vendors, contractors, professionals, staffing agencies and the like. Forms necessary to apply for various licenses and accreditation can also be provided.

For example, FIG. 6 includes a table showing third parties that may have to be consulted for licensing, such as Medicare Certified Ambulatory Surgery Center building regulations. According to an embodiment of the present invention, contact information or links to such third parties are provided. In an implementation in which the user accesses the Generating Section 30 via the an electronic network, such as the Internet, and the business plan and project facilitation are provided to the user on a monitor or display, the third parties listed in FIG. 6 may have hyperlinks that could send the user to the web pages of government, state or local agencies, to forms required for various types of licenses or accreditation, or to other information.

At S13 of FIG. 1, the user decides whether additional modeling of the target venture is desirable at this time and if so, the user may enter additional supplemental or override information, or change or update previously entered supplemental and override information, and enter confidence tags (or change or update previously entered confidence tags) by returning to S7 and S8 and submitting the information to the Generating Section 30. The Generating Section 30 upon receiving the new override, supplemental, and user confidence tag information is returned to S9.

In this way, the system provides a reiterative process, allowing the user to model various assumptions and conditions for the venture or to provide more comprehensive information for the venture as information about prevalent conditions and assumptions become known.

At S13, when the user decides that additional modeling for the venture is not desired, the user may accept the business plan and project facilitation outline generated and proceed to S14. The information so arrived at may be saved by the system for a future presentation to the user in a secure electronic folder, such that the folder could later be accessed by the user following the user's authentication by the system. The information could also be used in the future, if the user wishes to run additional modeling, planning or facilitation. Such future modeling may be based on additional information or more accurate or updated information as it becomes known.

The present invention envisions two functions, a business planning function and a project facilitation function. However, the system may provide only the business plan or the project facilitation for the venture. Also, while two functions are described, the business planning function and the project facilitation function may be provided to the user in an integrated fashion, as separate functions, or as separate reports returned.

The present invention also provides a method for valuation by considering the financial parameters and risk assessments. The method in one aspect may perform valuation based on the detailed cost identification and revenue generation formulas. The method may expand the above-described system by allowing for additional analysis to identify current capital equipment and costs, and future capital needs and replacements. Additionally, it may provide the ability to look at current practice compared to future practice scenarios.

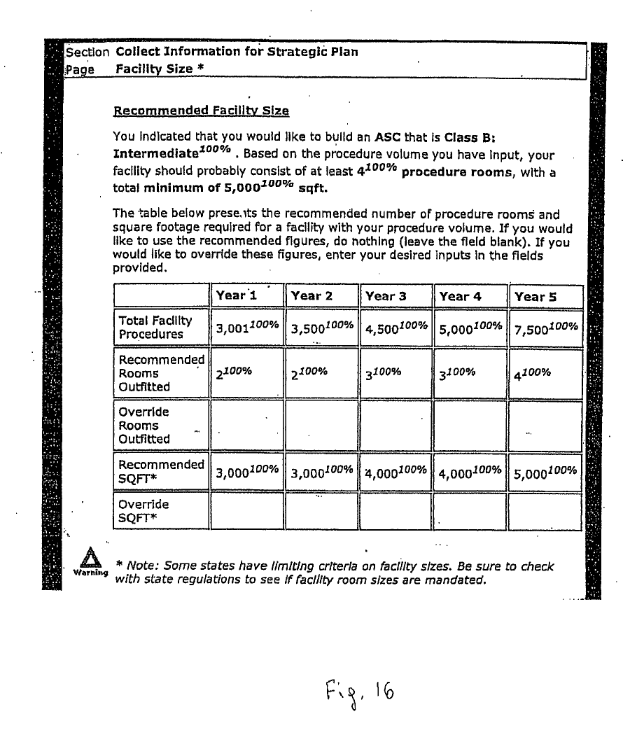

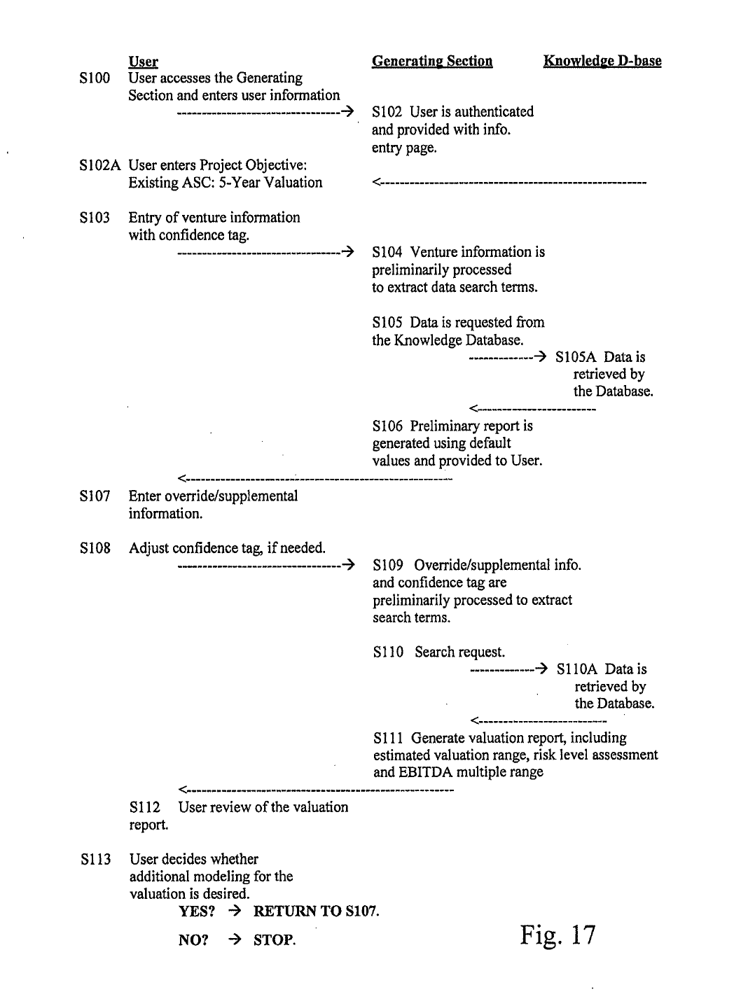

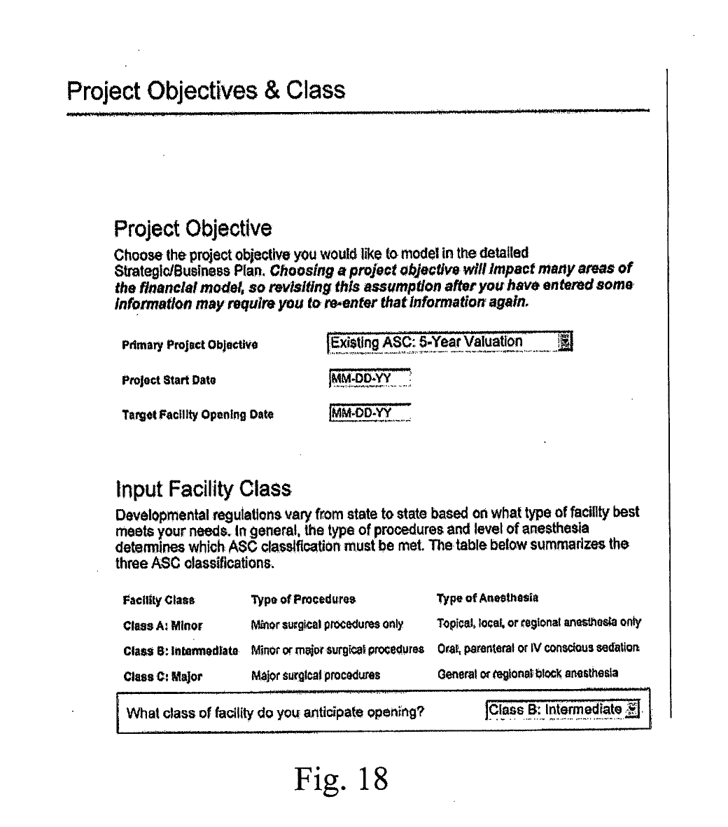

FIG. 17 is a flow diagram illustrating the valuation process of the present disclosure in one embodiment. A user may perform similar steps as those performed for the planning process shown in FIG. 1, for example, to initiate and enter values for the valuation. At S100, user accesses the generating section and enters user information and at S102, user is authenticated and provided with information entry page in a similar manner described with reference to FIG. 1. At 102A, the user specifies a project objective, e.g., a 5-year valuation for an existing center. At S103, the user enters venture information with confidence tag,. At S104, venture information is preliminarily processed to extract data search terms. At S105, using the data search terms, knowledge base is queried, and at S105A, data is retrieved from the database. The venture information may include, for example, the data shown in FIGS. 18-25. At least some of the values in those tables may be populated with default values. A user may change the entries shown in those tables, for example, by inputting different values in the fields. At S106, preliminary report is generated using the information and the report is provided to user. The generated report may include a valuation, business plan and/or a project facilitation outline, or a portion thereof, and is reported to the user for example, via a user interface such as web pages, etc. At 107, user may override or supplement the information Examples of preliminary reports are shown in FIGS. —26-29. At 108, confidence tag may be adjusted if or as needed. At S109, the override and/or supplemental information and confidence tag are preliminarily processed to extract search terms. At S110, a search based on the search terms is requested and at S110A, data is retrieved from the database.

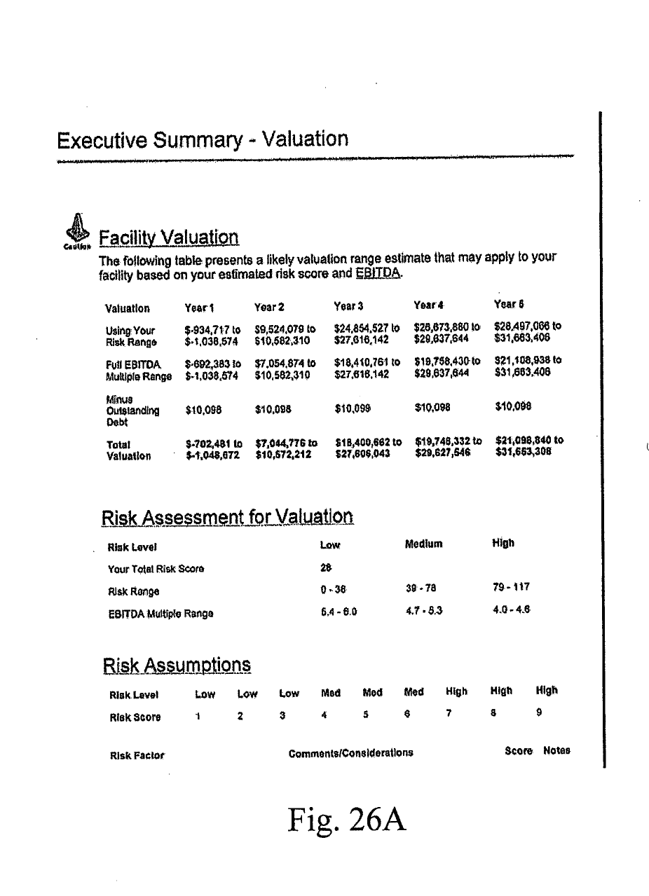

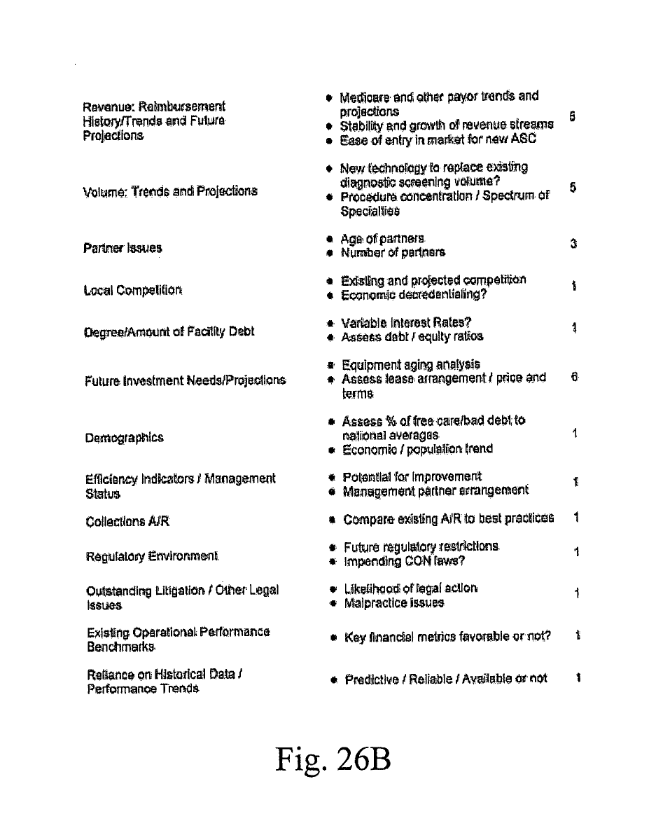

At S111, valuation report is generated, for example, including estimated valuation range, risk level assessment and EBITDA multiple range. An example of a valuation report is shown in FIGS. 26A-29. The valuation process in one embodiment evaluates various information about the facility obtained, for example, from a user and for example, from the database to compute the financial value of the facility. Such information may include, but is not limited to, amount and types of assets such as equipments, future assets, present and future revenues, depreciation factors, operating costs and expenses such as staff salaries, supply costs, marketing, dues and education costs, insurance costs, maintenance and repair costs, lease, etc. Depreciable life may vary from setting to setting. For example, a facility may call for a 5-year depreciation schedule. For other, a modified accelerated depreciation method to write off more of the equipment faster may be used. Any known or will be known valuation or accounting method may be used taking into account various information provided in the database and/or by a user.

At S112, user reviews the valuation report and at S113, the user may decide whether additional modeling for the valuation is desired. If additional modeling is desired, the method returns to step S107, where previously entered data may be adjusted to model another valuation.

Information collected from a knowledge base and/or user may include, but is not limited to, contact information and model configuration parameters such as key contact or principal advocate, detailed information on new and/or existing partners, detailed information about office, wage index and local regulations. Further, information collected for the strategic plan or valuation may include, but is not limited to, project objectives and class, partner objectives and goals such as information pertaining to existing practice and new partners. Additional information collected may include information about facility revenues, facility size and financing, information regarding contingency reserve, tax, and legal considerations, asset financing, financing parameters, investment distribution, risk factors, ongoing working capital and/or discount rate.

Information about facility revenues may include, but is not limited to, payor information such as current volume and modeling preferences for existing and new partners which may describe practice related information such as procedure carry-over and ramp-up, estimate payor changes, procedure primacy, reimbursement modeling preferences, for instance, naming different insurance institutions, and information relating to receivables, bad debt, and free care.

Facility size and financing information may include itemized medical equipment, non-medical capital equipment modeling preferences, non-medical equipments in additional non-GI room, bathroom, consultation and/or nurse room, manager's office, general facility, housekeeping, office and/or reception, recovery bays, staff lounge, and waiting room. Information relating to contingency reserve, tax, and legal considerations may include but is not limited to information about contract services, personnel status such as clinical or non-clinical, staffing levels, compensation, information about supplies.

Strategic plan or valuation results may provide an executive summary including, for example, for a medical facility, facility description, revenues, capital, expenses, and valuation; key financial metrics; analysis summary of the valuation projection such as physician investment and return, capital requirement summary, medical capital equipment requirements, non-medical capital equipment requirements; revenue details; procedure mix and growth by partner; procedure mix and reimbursement for existing and/or new partners; expense details such as contract service costs, staffing expenses, supply costs such as those for accessories, medical supplies, medications, office supplies, reprocessing supplies, marketing, dues, and education costs, insurance costs, maintenance and/or repair costs, utilities, postage, and paper goods costs, depreciation and/or lease expenses; interest and principal repayments; break-even analysis. The results further may provide an option for selecting a developer for building the facility, suggest timeline, suggest partner objectives alignment and vision, and key success factors including information on legal structures and/or accredition.

FIG. 18 illustrates an example input user interface for allowing a user to enter project objective data according to one embodiment of the present invention. For example, a user may select to perform “5-year valuation” for an exiting ASC shown in FIG. 18.

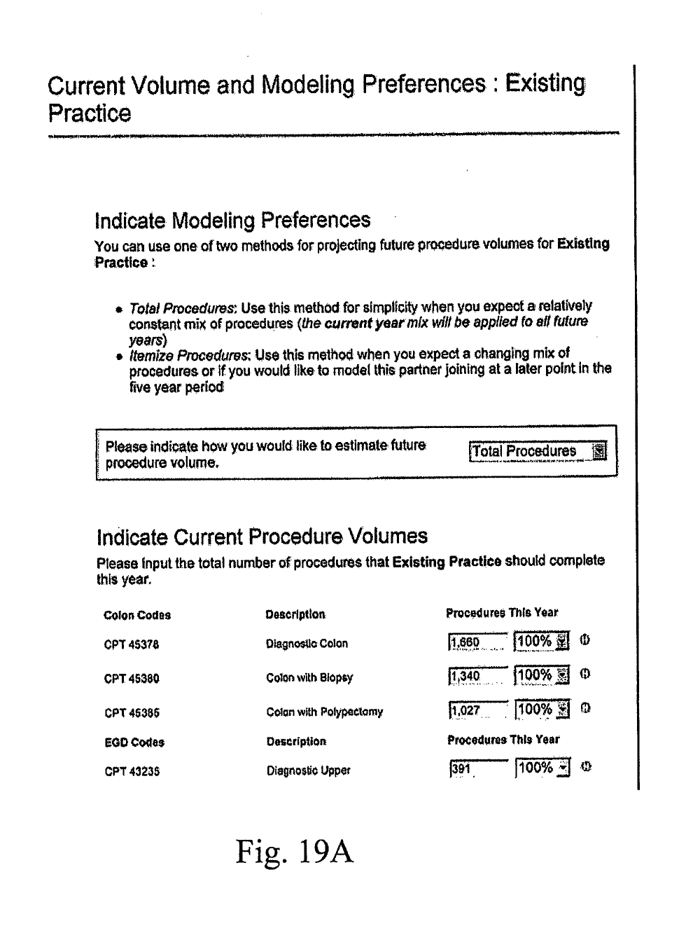

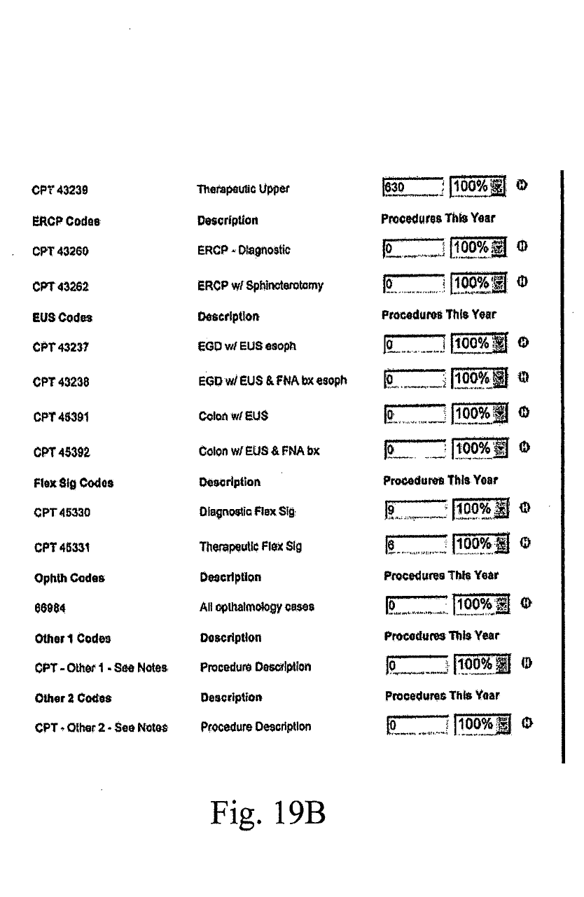

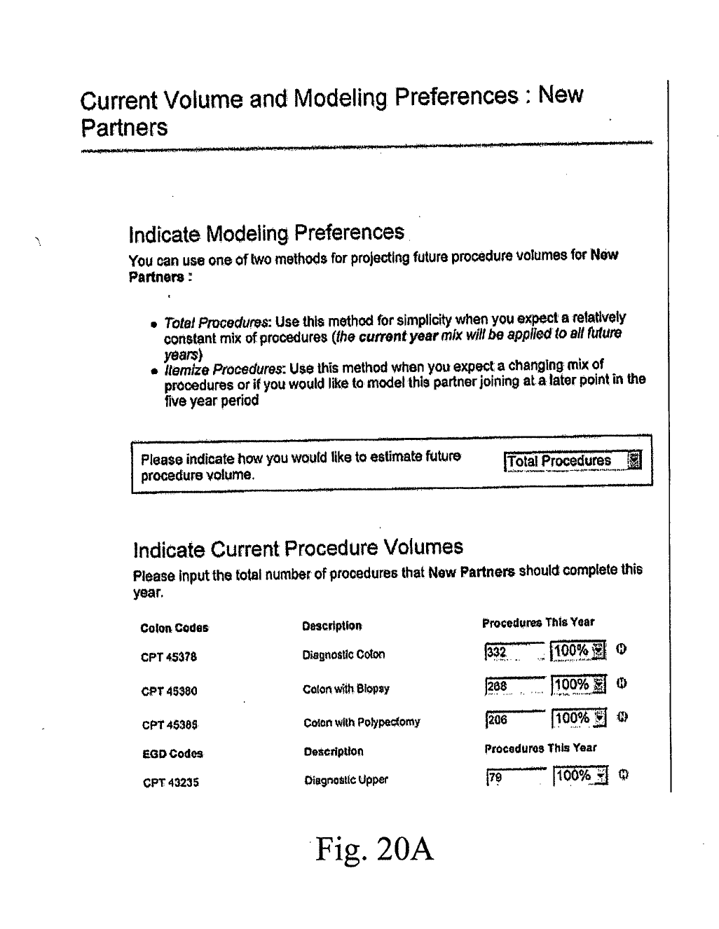

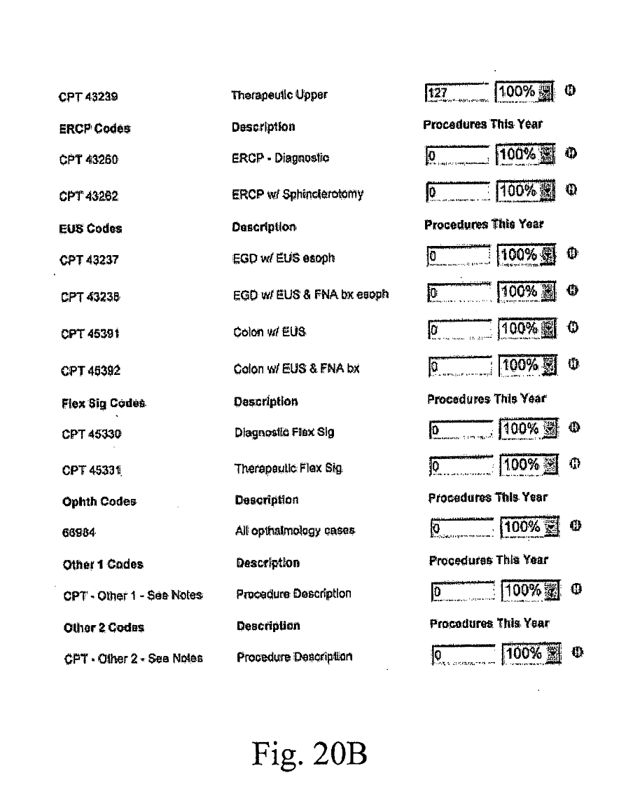

FIGS. 19A and 19B illustrate a user interface for allowing a user to enter modeling preference, for example, for existing practice. A user may select one of two methods for projecting future procedure volumes for existing practice. Total procedures method may be selected for simplicity when a user expects a relatively constant mix of procedures; and itemize procedure method may be selected when a user expects a changing mix of procedures or when modeling a new partner joining at a later point in the valuation period. A user also enters data associated with total number of procedures as shown in FIGS. 19A-19B. Similarly, FIGS. 20A and 20B illustrate a user interface via which a user may enter modeling preference for a new practice.

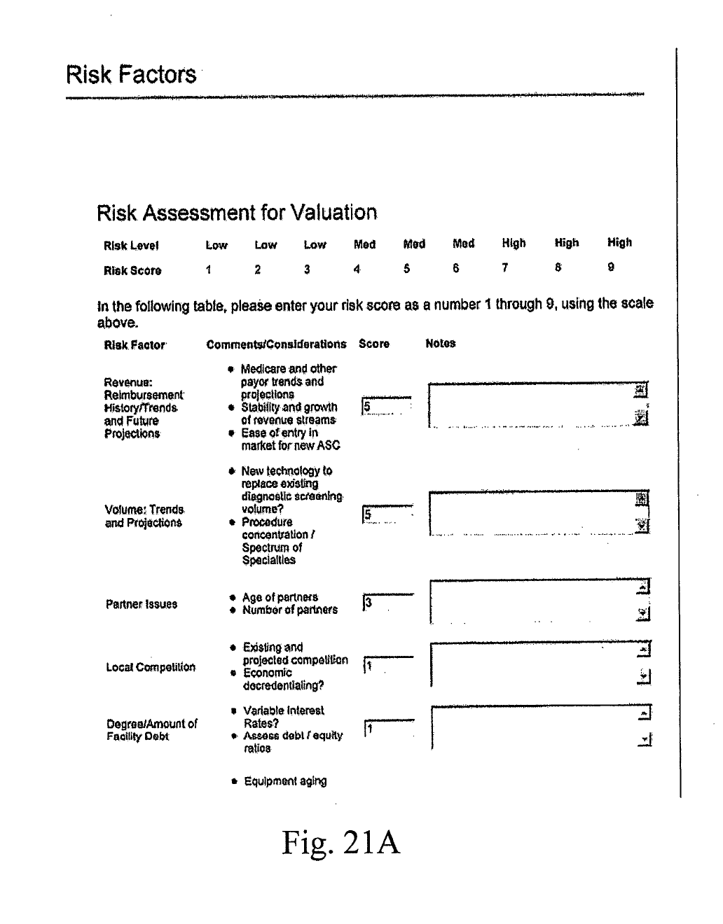

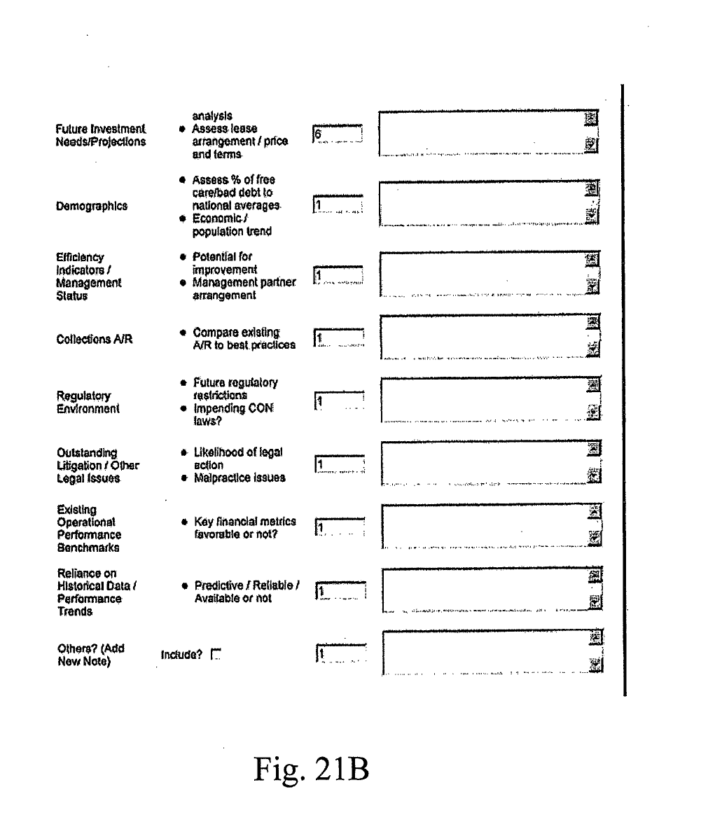

FIGS. 21A and 21B illustrate an example user interface via which a user may enter various risk factors for assessing risks considered in the valuation process. The values identify key risks for the financial success of the center. A user may also input values which estimate the severity of risk, for example, based on a numerical system from 1(low) to 9(high) for each key risk factor. Risks factors may include, for examples, risks associated with revenue, volume of work performed, partners, local competition, debt, efficiency, collection, regulations, possible litigations, operational performance, etc.

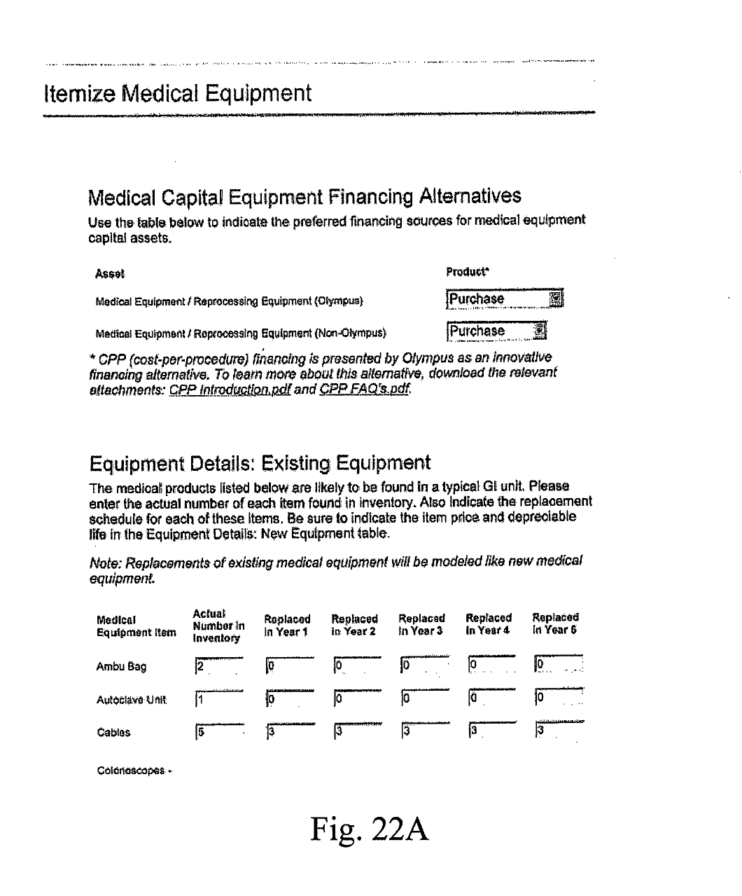

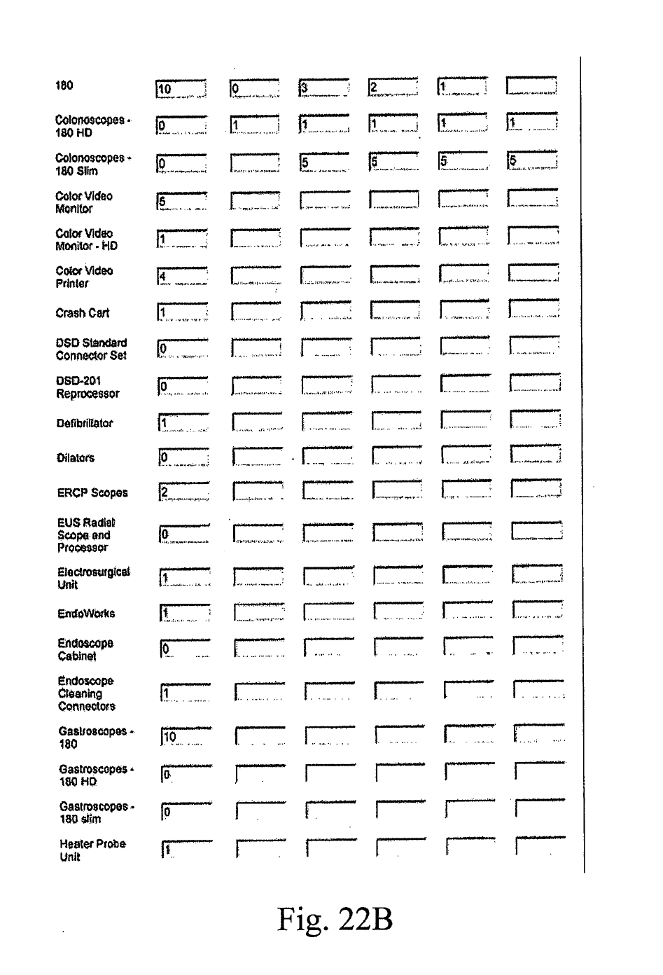

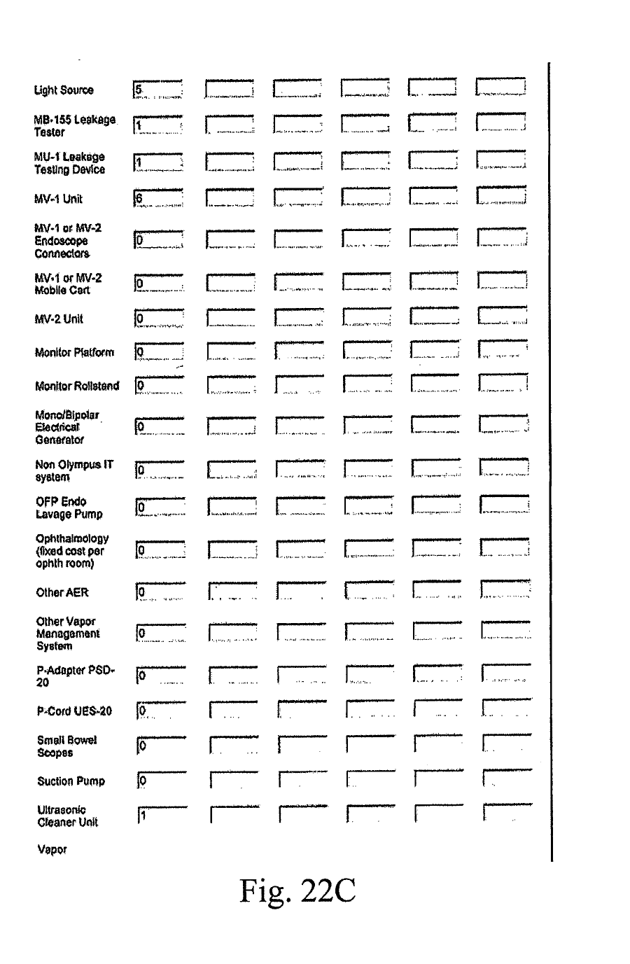

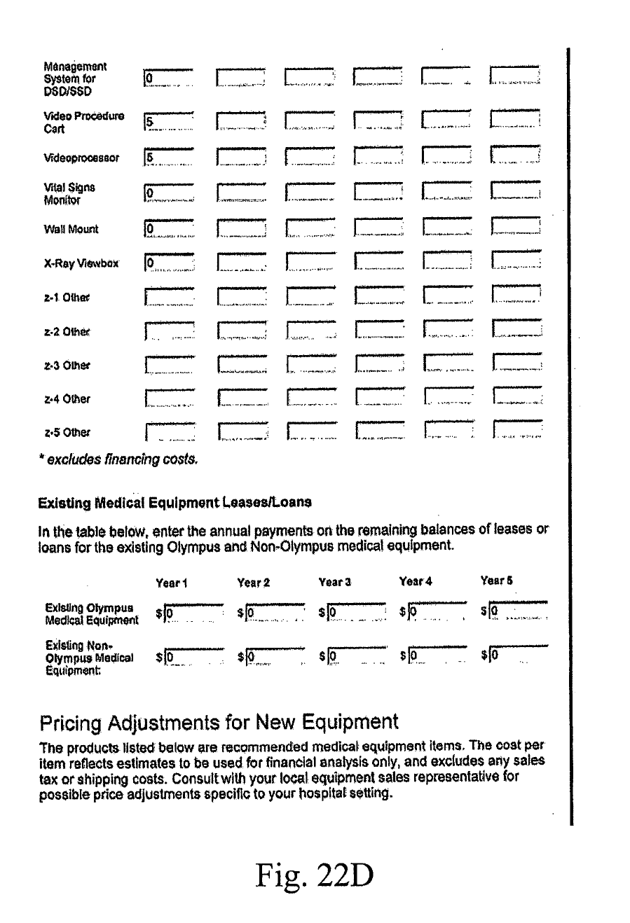

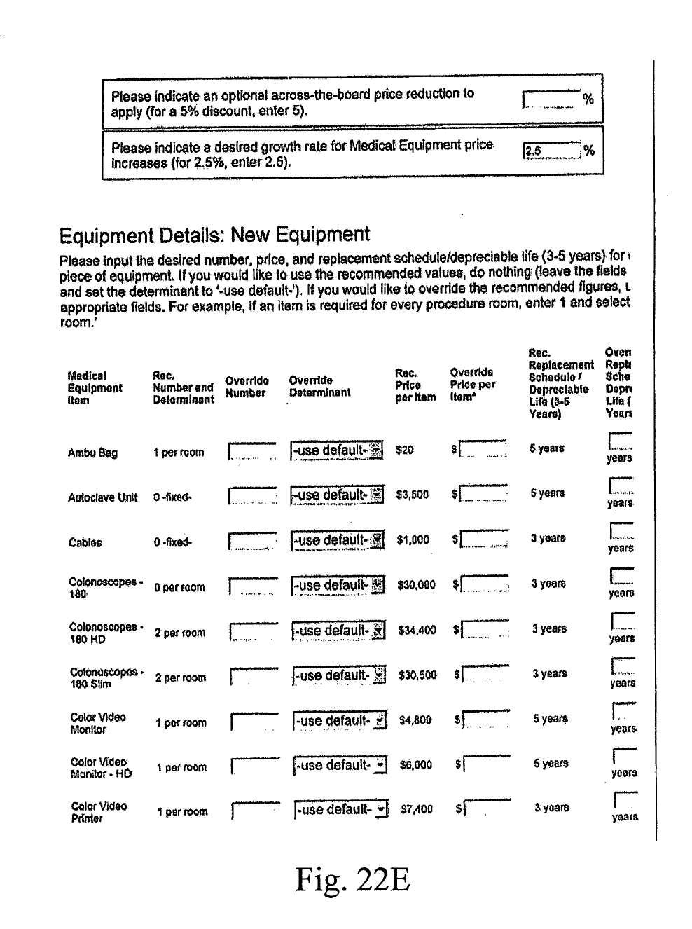

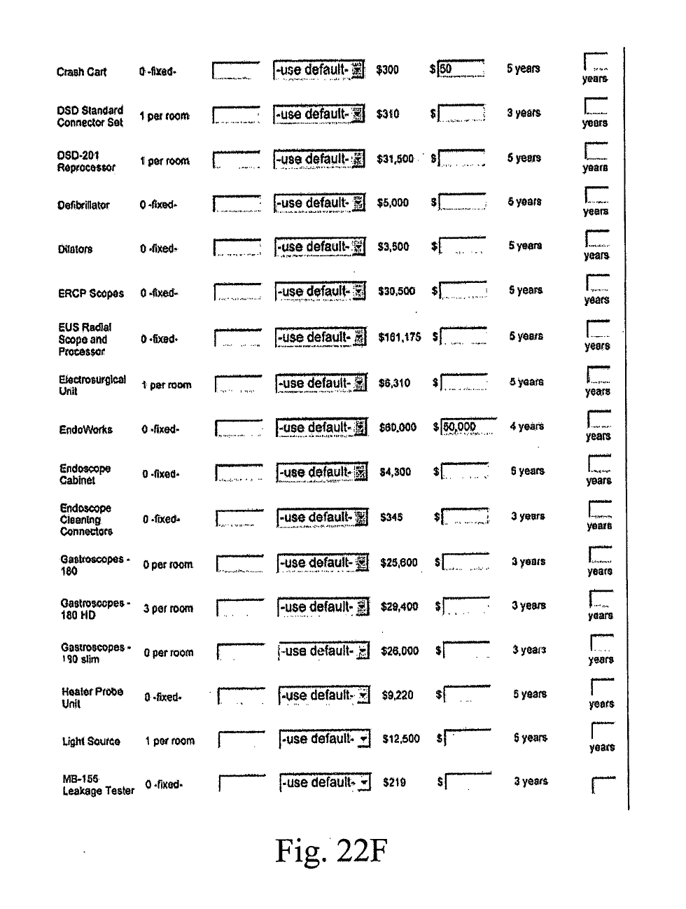

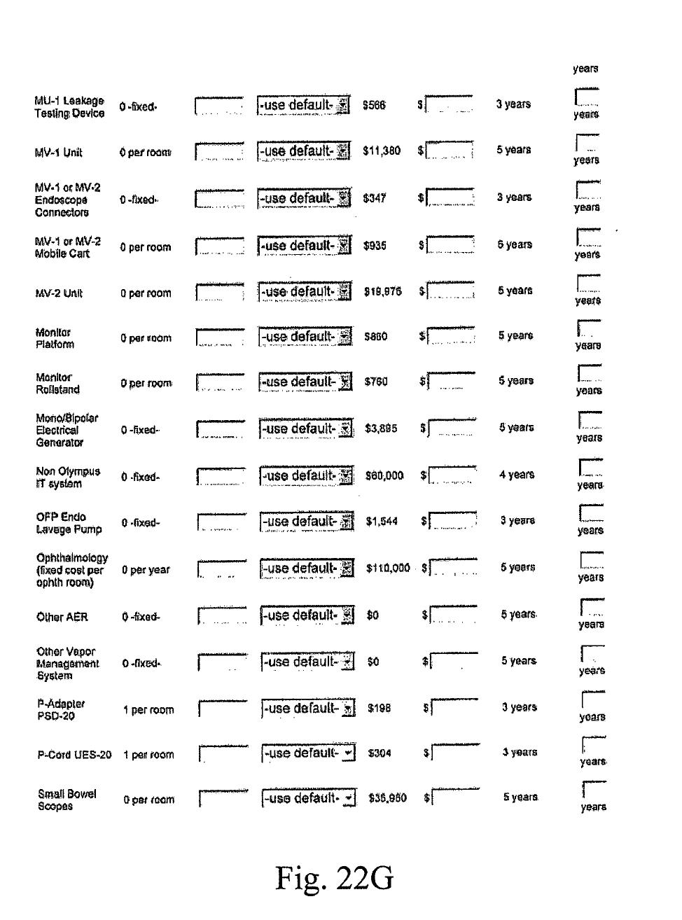

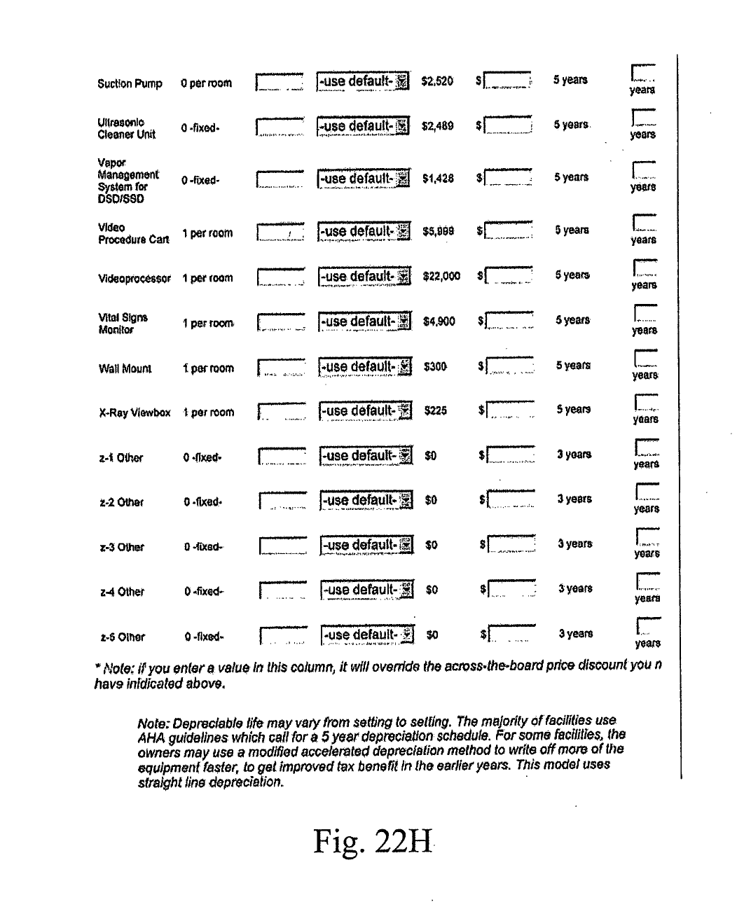

FIGS. 22A-22H illustrate an example of a table that shows expenses for existing and new projected medical equipments or assets in the facility being valued. Valuation for example may include inventorying and inputting the equipment currently in the facility and when it will need to be replaced. This provides an assessment of future expenses for the facility.

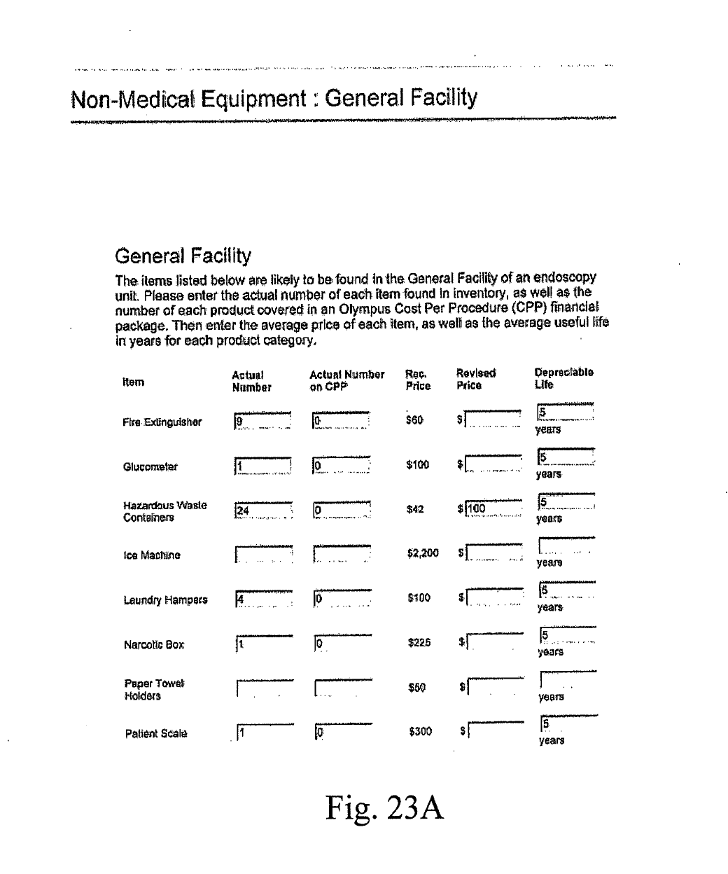

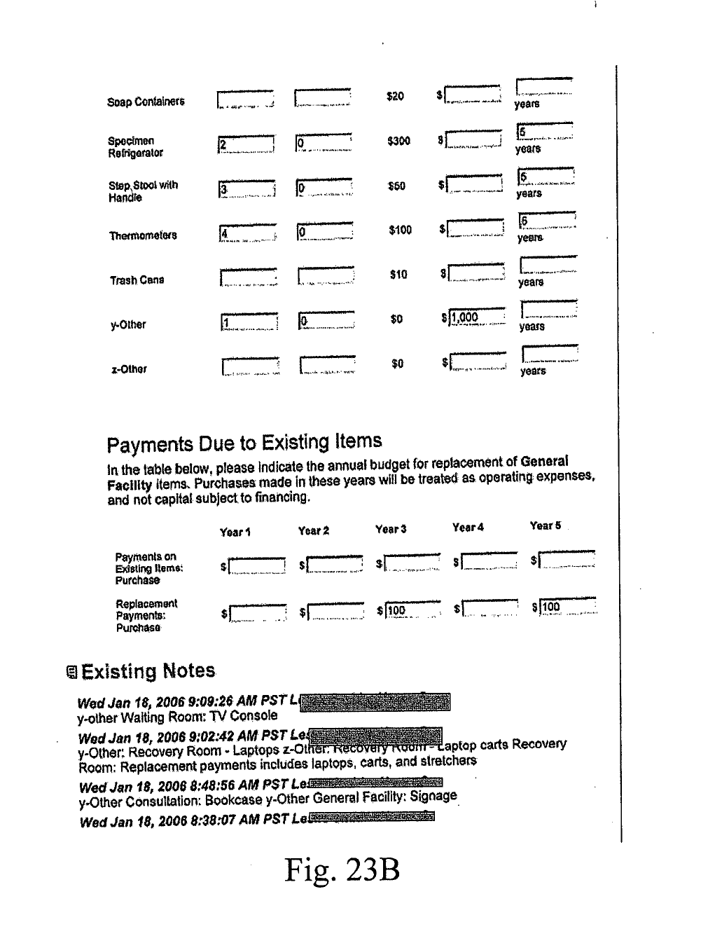

FIGS. 23A and 23B illustrate an example of a table that shows expenses for existing and new projected non-medical equipments or assets in the facility being valued. General facility valuation may include inventorying and inputting the equipment currently in the facility and when it will need to be replaced. This provides an assessment of future expenses for the facility.

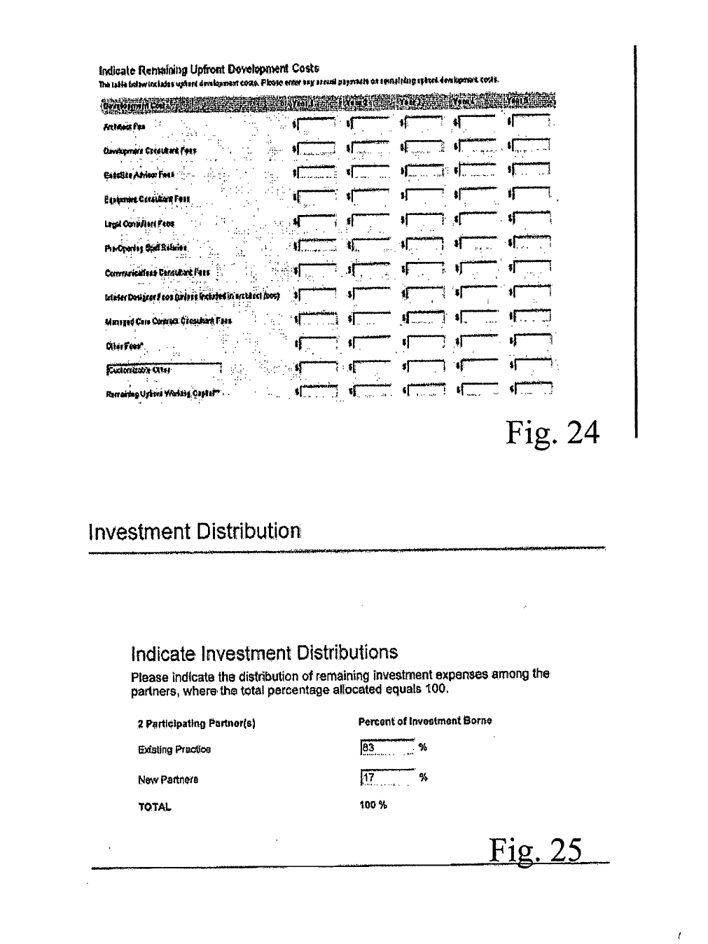

FIG. 24 illustrates a table listing upfront development cost. A user may inputs annual payments on remaining upfront development costs to identify debt load. Development costs, for example, my include architect fee, consultant fees, site advisor fees, equipment consultant fees, legal consultant fees, pre-opening staff salaries, communications consultant fees, interior designer fees, managed care contract consultant fees, etc.

FIG. 25 illustrates the investment distribution in one embodiment. The distribution may be tailored to look at current and new investors.

FIGS. 26A and 26B illustrate a user interface, for example, a table, in one embodiment that displays executive summary of the valuation. The table provides a valuation summary of the calculations performed by the planner to estimate valuation range, risk level assessment, and EBITDA Multiple Range.

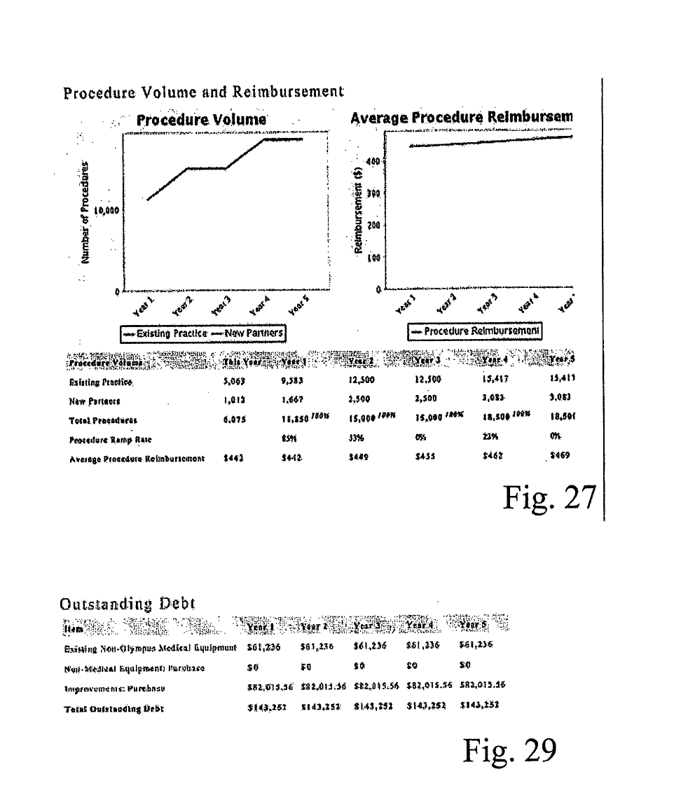

FIG. 27 shows a user interface that presents procedure volume and reimbursement for existing and new practice. The output shown charts medical procedure volume and reimbursement by existing and new partners.

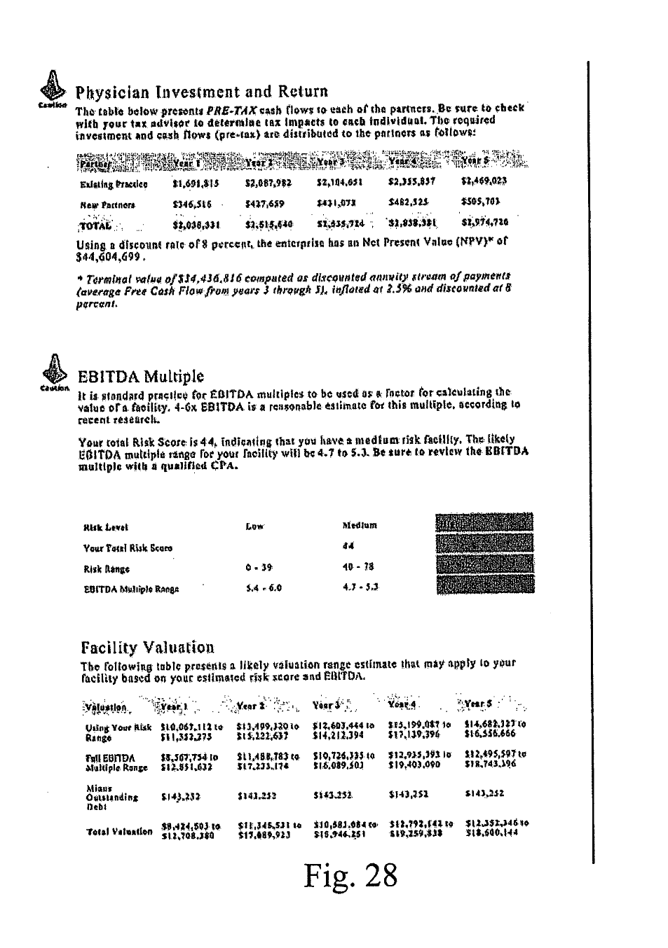

FIG. 28 illustrates physician investment and return, which summarizes the pre-tax cash flows to existing and new partners, EBITDA multiple range based on risk score and risk range and facility valuation.

FIG. 29 illustrates a table listing outstanding debt, which summarizes the existing debt and anticipated improvements/purchases over the next years of the valuation period, for example, next 5 years as entered in FIG. 18.

The valuation process of the present disclosure may utilize any known or will be known accounting or like computation or formulas to determine the valuation based on the user entered information and information obtained from the knowledge base, for example, as described above. In one embodiment of the present disclosure, a novel method is used to model a valuation in which cost per procedure (CPP) and/or lease financing alternative are added to the upfront working capital. Such addition may introduce a secondary effect into modeling that may be described as a circularity problem. The planner of the present disclosure in one embodiment calculates the amount of working capital required as a percentage of operating costs, typically 3 months of operating expenses. However, CPP and leasing financing are operating expenses. As a result, the CPP or lease financing of upfront working capital becomes included in the very same operating costs that are used to determine the working capital to be financed. The effect is that the working capital calculation is required as an input to itself. In order to circumvent the above effect, the method and system of the present disclosure uses the following underlying formulas and applications.

Underlying formulas—Capital lease

Year 1
WCR1=(OP1+PMT)*M/12*(1+(C/100))
PMT=(WCR1+DEV)*(RF*12)
C1=(OP1+PMT)*(C/100)
WCR1=(OP1+((WCR1+DEV)*RF*12))*(M/12)*(1+(C/100))
Let A=(M/12)*(1+(C/100))WCR1=OP1*A+((WCR1+DEV)*(RF*12))*A WCR1=OP1*A+(WCR1*(RF*12))*A+(DEV*(RF*12))*A WCR1−(WCR*(RF*12/T)*A)=(OP1*A)+(DEV*(RF*12))*A WCR1(1−(RF*12)*A)=(OP1*A)+(DEV*(RF*12))*A WCR1=((OP1*A)+(DEV*(RF*12))*A)/(1−(RF*12)*A)
OP1=Operating Costs (Year 1)
DEV=Upfront Development Costs
WCR1=Working Capital Required (Year 1)PMT=Payment on WCR1
C=Contingency Allowance
C1=Contingency (Year 1)
RF=Rate Factor Applied (see next page for RF determination)
M=Months of Working Capital Required

Underlying formulas—Capital

Year 1
WCR1=(OP1+PMT)*M/12*(1+(C/100))
PMT=(WCR1+DEV)*RF*P1/PT
C1=(OP1+PMT1)*(C/100)
WCR1=(OP1+((WCR1+DEV)*RF*P1/PT))*(M/12)*(1+(C/100))
Let A=(M/12)*(1+(C/100))WCR1=OP1*A+((WCR1+DEV)*(RF*P1/PT))*A WCR1=OP1*A+(WCR1*(RF*P1/PT))*A+(DEV*(RF*P1/PT))*A WCR1−(WCR*RF*P1/PT)*A)=(OP1*A)+(DEV*(RF*P1/PT))*A WCR1(1−(RF*P1/PT)*A)=(OP1*A)+(DEV*(RF*P1/PT))*A WCR1=((OP1*A)+(DEV*(RF*P1/PT))*A)/(1−(RF*P1/PT)*A)
PMT1=Payment on WCR1 in Year 1
P1=Procedures in Year 1
PT=Total Procedures in Years 1-5

Using the above underlying formula, correct rate factor may be applied as follows for the first year (year 1) as applied to capital lease and capital CPP. To compute the required upfront working capital (WCR1), the appropriate rate factor (RF) is applied. Since the rate factor is required to compute WCR1, we iterate through all the available rate factors to determine the appropriate RF to use:
RF1=Asset value less than $250K
RF2=Asset value under $500K but greater than or equal to $250K
RF3=Asset value greater than or equal to $500K
Step 1: Assume WCR1<$250K
Step 2: Calculate WCR1 based on RF1(A=WCR1(RF1))
Step 3: Test assumption that WCR1<$250K
If WCR1>$250K then assumption is incorrect, retest with RF2, else Assumption is correct, RF1 is correct
(If A<250,000 then B=WCR1 (RF2) else B=A)
Step 4: Test assumption that<$500K If WCR1>=$500K then assumption is incorrect, use RF3, else Previous assumption is correct
(If B>500,000 then C=WCR1(RF3) else C=B)

Then, the following underlying formulas may be used for years 2-5 of the valuation period:

Capital Lease—Years 2-5
PMT=(WCR1+DEV)*(RF*12)
CN=(OPN+PMT)*(C/100)
WCRN=(OPN+PMT)*M/12*(1+(C/100))
Where
OPN=Operating Costs (Year N)
DEV=Upfront Development Costs
WCR1=Working Capital Required (Year 1)
WCRN=Working Capital Required (Year N)PMT=Payment on WCR1
C=Contingency Allowance
CN=Contingency (Year N)
RF=Rate Factor Applied (see next page for RF determination)
M=Months of Working Capital RequiredCapital CPP—Year 2-5
PMTN=(WCR1+DEV)*RF*PN/PT
CN=(OPN+PMTN)*(C/100)
WCRN=(OPN+PMTN)*M/12*(1+(C/100))
Where,PMTN=Payment on WCR1 in Year N
PN=Procedures in Year N
PT=Total Procedures in Years 1-5

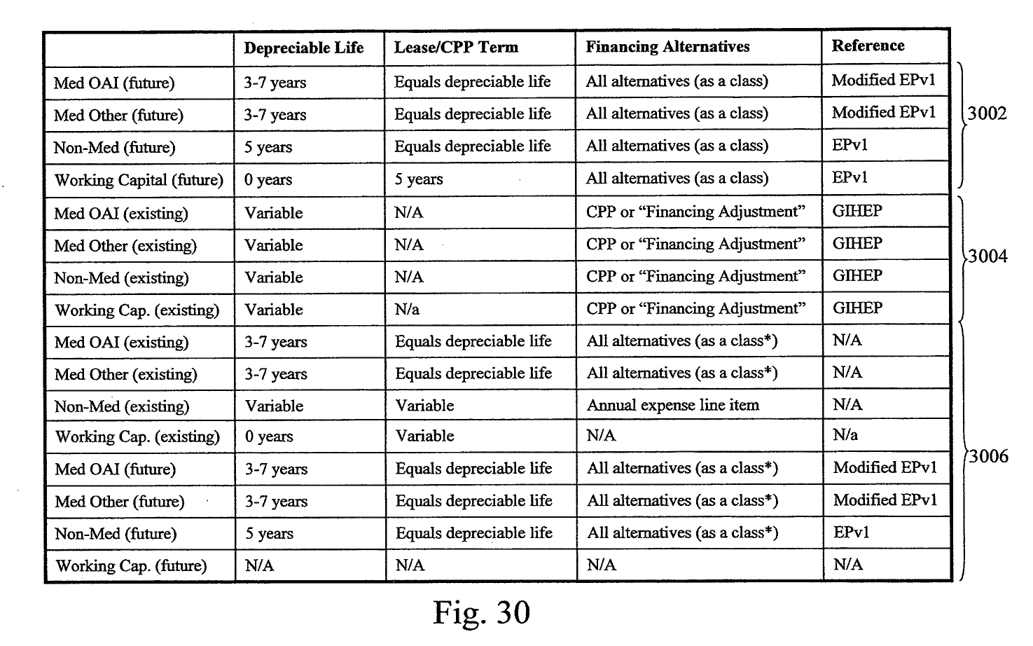

FIG. 30 illustrates a table showing financing formulas that may be used in the valuation process in one embodiment. For example, entries at 3002 show formulas that may be used for a new facility, entries at 3004 show formulas that may be used for ID cost, and entries at 3006 show formulas that be used for valuation, for example, for 5-year valuation.

The system and method of the present disclosure may be implemented and run on a general-purpose computer or computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A business valuation method for an endoscopy services venture, the method comprising:
receiving information associated with the endoscopy services venture;
generating a preliminary valuation report based on the received information;
providing the preliminary valuation report to a user;
allowing the user to change the received information; and
generating a valuation report customized for the endoscopy services venture based on the changed information.

2. The method of claim 1, further including:
inputting the received information.

3. The method of claim 1, further including:
retrieving a plurality of default values from knowledge based on at least some of the received information;
the step of generating a preliminary valuation report including generating a preliminary valuation report based on the received information and at least some of the plurality of default values; and
the step of generating a valuation report includes generating a valuation report customized for the endoscopy services venture based on the changed information and said at least some of the plurality of default values.

4. The method of claim 1, further including:
reporting the valuation with risk assessment.

5. The method of claim 1, wherein the plurality of default values includes at least one of a requirement, a goal, a forecast and an output for the endoscopy services venture.

6. The method of claim 1, further including:
receiving a user confidence tag representing a user estimate of the reliability of the tagged value for the received information, and wherein a provided value of the valuation is flagged with a reliability index according to the user confidence tag.

7. The method of claim 1, wherein the valuation is generated based on average scores for the industry of the venture, taking into account values specific to a local business environment according to a location of venture.

8. The method of claim 7, wherein the location of the venture includes information about at least one of a country, state, province, county, and town of the venture.

9. The method of claim 1, further including:
after providing the valuation report, allowing a user to perform additional valuation by returning to the step of allowing the user to change the received information.

10. A business valuation system for an endoscopy services venture, comprising:
a user interface configured to receive information associated with the endoscopy services venture;
a controller configured to generate a plurality of default values based on endoscopy services knowledge database-provided data retrieved according to the received information;
the user interface configured to receive additional information to one of supplement and override at least one of the previously entered information and a default value of the plurality of provided default values; and
the controller configured to generate a valuation report customized for the endoscopy services venture, based on the default value information and the received information, and to output the generated valuation report.

11. The system of claim 10, wherein the plurality of default values includes at least one of a requirement, a goal, a forecast and an output for the endoscopy services venture.

12. The system of claim 10, wherein a user confidence tag representing a user estimate of the reliability of the tagged value is received for the information, and wherein a provided value of the valuation based on the information is flagged with a reliability index according to the user confidence tag for the information.

13. The system of claim 10, wherein the user interface is further operable to receive a project objective.

14. The system of claim 10, wherein the valuation is generated based on average scores for the industry of the venture, taking into account values specific to a local business environment according to a location of venture.

15. The system of claim 14, wherein the location of the venture includes information about at least one of a country, state, province, county, and town of the venture.

16. The system of claim 10, wherein the controller is further operable to allow a user to additional valuation modeling after generating the valuation report.

17. A processor readable medium embodying a program of instructions for carrying out a valuation method for an endoscopy services venture, the instructions comprised of:
means for receiving information associated with the endoscopy services venture;
means for providing a plurality of default values based on endoscopy services knowledge database-provided data retrieved according to at least some of the received information;
means for allowing the user to change the received information; and
means for reporting a valuation customized for the endoscopy services venture, based on the received information.

18. The processor readable medium of claim 17, wherein the plurality of default values includes at least one of a requirement, a goal, a forecast and an output for the endoscopy services venture.

19. The processor readable medium of claim 17, wherein a user confidence tag representing a user estimate of the reliability of the tagged value is received for the information, and wherein a provided value of the valuation based on the information is flagged with a reliability index according to the user confidence tag for the information.

20. The processor readable medium of claim 19, wherein the generated valuation is determined based on at least a volume of endoscopic procedures performed by the venture.

21. The processor readable medium of claim 17, wherein the valuation is generated based on average scores for the industry of the venture, taking into account values specific to a local business environment according to a location of venture.

22. The processor readable medium of claim 21, wherein the location of the venture includes information about at least one of a country, state, province, county, and town of the venture.
